(19) United States
(12) Patent Application Publication
(10) Pub. No.: US 2007/0266080 A1
(43) Pub. Date: Nov. 15, 2007

(54) System and Method for Virtual Benchmarking

(76) Inventors: Steven Duane McNicol, Parker, CO (US); Chad Michael Larsen, Parker, CO (US); Tony John O'Neill, Medina, WA (US); Roberto Yslas, Foxfield, CO (US); Richard Samuel Lawrence, Denver, CO (US); Blas Yslas JR., Aurora, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/379,020

(22) Filed: Apr. 17, 2006

(51) Int. Cl. G06F 15/16

(52) U.S. Cl. 709/203

(57) ABSTRACT

The various embodiments of the present invention include systems and methods for monitoring, analyzing and virtually benchmarking system, process and/or assets. By breaking down each of a plurality of similarly configured processes, systems or assets into a desired level of component specificity and appropriately identifying such specificity in one or more databases, each component in each of the process, systems and/or assets can be compared separately and or in a group to similarly situated components and to a virtual benchmark obtained by a combination of each of the individually reported components.

### BACKGROUND

Complex and/or multivariable processes, systems and/or assets (hereafter, collectively “Processes”) exists in all facets of the 21^{st} century economy. Examples of such Processes include, but are not limited to, waste water treatment facilities and water treatment facilities.

Often a manufacturer or user of such Processes desires to optimize the performance of a given Process but lacks systems and methodologies for measuring and analyzing current performance in view of the wide, system level variability between a given Process and other similarly situated Processes. Thus, a need exists for systems and methods for monitoring, comparing, and assessing the performance of any given Process against a Virtually Benchmarked Process (“VBP”).

### SUMMARY

The various embodiments of the present invention provide systems and methods for determining a VBP for a given Process and thereby optimizing an analyzed Process (“AP”) with respect to one or more criteria. Specifically, the AP is broken down into its component parts or process levels and compared to substantially identical components/process levels identified for a VBP. The VBP is generated from a database of similar Processes, wherein each similar Process has also been broken down to a given component/process level and metrics for such component/process collected and analyzed. By creating a VBP at any measurable component or level of specificity, the performance of an AP may be monitored and analyzed and performance enhancements in the AP recommended, suggested and modeled.

### DESCRIPTION OF THE DRAWING FIGURES

FIG. 1 is a schematic representation of a system adapted to implement one embodiment of the present invention.

FIG. 2 is graphical representation of the breaking down of a waste water treatment facility into component elements at various levels of specificity for at least one embodiment of the present invention.

FIG. 3 is a representation of a web page adapted for use with a web server adapted to support the monitoring, analysis and virtual benchmarking of a Process for at least one embodiment of the present invention.

FIG. 4 is a representation of sign-on active server page adapted for use with a web server adapted to support the monitoring, analysis and virtual benchmarking of a Process for at least one embodiment of the present invention.

FIG. 5 is a representation of a home active server page adapted for use with a web server adapted to support the monitoring, analysis and virtual benchmarking of a Process for at least one embodiment of the present invention.

FIGS. 6a-b are representations of a contact information active server page adapted for use with a web server adapted to support the monitoring, analysis and virtual benchmarking of a Process for at least one embodiment of the present invention.

FIG. 7 is a representation of an account information active server page adapted for use with a web server adapted to support the monitoring, analysis and virtual benchmarking of a Process for at least one embodiment of the present invention.

FIGS. 8a-d are representations of an administration active server page adapted for use with a web server adapted to support the monitoring, analysis and virtual benchmarking of a Process for at least one embodiment of the present invention.

FIGS. 9a-b are a representation of a benchmark page adapted for use with a web server adapted to support the monitoring, analysis and virtual benchmarking of a Process for at least one embodiment of the present invention.

FIG. 10 is a representation of a process summary active server page adapted for use with a web server adapted to support the monitoring, analysis and virtual benchmarking of a Process for at least one embodiment of the present invention.

FIG. 11 is a representation of a facility comparison active server page adapted for use with a web server adapted to support the monitoring, analysis and virtual benchmarking of a Process for at least one embodiment of the present invention.

FIG. 12 is a representation of a process history active server page adapted for use with a web server adapted to support the monitoring, analysis and virtual benchmarking of a Process for at least one embodiment of the present invention.

FIG. 13 is a representation of a dashboard active server page adapted for use with a web server adapted to support the monitoring, analysis and virtual benchmarking of a Process for at least one embodiment of the present invention.

FIGS. 14a-c are a representation of a report configuration active server page adapted for use with a web server adapted to support the monitoring, analysis and virtual benchmarking of a Process for at least one embodiment of the present invention.

FIG. 15 is a representation of a target configuration active server page adapted for use with a web server adapted to support the monitoring, analysis and virtual benchmarking of a Process for at least one embodiment of the present invention.

FIG. 16 is a representation of a quality configuration active server page adapted for use with a web server adapted to support the monitoring, analysis and virtual benchmarking of a Process for at least one embodiment of the present invention.

FIG. 17 is a representation of a process model upload active server page adapted for use with a web server adapted to support the monitoring, analysis and virtual benchmarking of a Process for at least one embodiment of the present invention.

FIG. 18 is a representation of a maintenance upload active server page adapted for use with a web server adapted to support the monitoring, analysis and virtual benchmarking of a Process for at least one embodiment of the present invention.

### DETAILED DESCRIPTION

The various embodiments of the present invention provide systems and methods for optimizing an AP by breaking the AP down to a desired level of specificity and comparing the AP, at the desired level of specificity, to a VBP also broken down to the desired level of specificity, wherein the VBP, at any given level of specificity, is generated based upon a plurality of other substantially similarly situated and similarly broken down Processes. In at least one embodiment, the characteristics of the other Processes, at the desired level of specificity, are identified in a database. By grouping together such other Processes, at the desired level of specificity, the VBP can be created against which other Processes, including but not limited to the AP, can be compared, modeled and desirably optimized at the desired level of specificity. Modeling and optimization of an AP can also be supported by the various embodiments of the present invention by using two or more VBP optimized, for example, at their respective levels of specificity, but, which when combined and modeled result in the optimization of the AP at a higher or lower level of specificity.

A wide variety of Processes may be monitored, analyzed and virtually benchmarked by the various embodiments of the present invention. In addition to the Process examples mentioned above, Processes can include, but are not limited to: refineries; petrochemical facilities; air traffic control systems; transportation systems; factories; power plants; food production and distribution systems; port operation systems; financial transaction processing systems; construction operations; product distribution systems; workflow; complex assets such as aircraft, ship, cars, computers, nuclear reactors and consumer electronics; and/or any other process, system or asset that involves multiple inter-related and interdependent elements and/or steps.

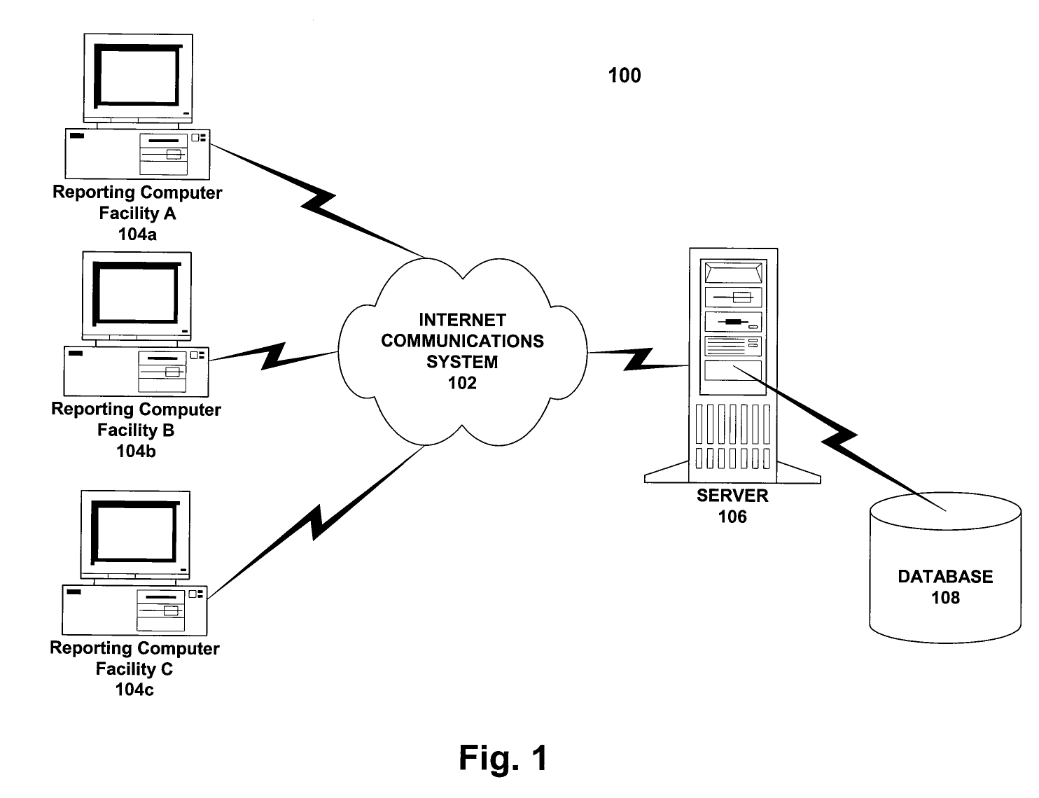

As shown in FIG. 1, one embodiment of a system 100 for virtual benchmarking a Process utilizes a communications system 102 to connect multiple, disparate facilities each connected to a reporting computer 104a-c. In one embodiment, the communications system utilizes in whole or in part the Internet. However, in other embodiments non-Internet communications systems may be used including but not limited to ATM, Ethernet, frame relay and others. The communications system can also be configured to utilize any desired combination, if any, of wired, wireless and/or satellite communications and can include private and/or public networks and communications mediums. Thus, it is to be appreciated that the various system embodiments of the present invention are essentially agnostic with respect to any given communications medium or system.

Similarly, the reporting computers 104a-c can be any device capable of reporting information regarding one or more Process components to a server or other communications and/or computing device. Examples of reporting computers include, but are not limited to, personal computers, SUN class workstations computers, main frame computers, super computers, handheld computers, personnel data assistants, integrated cell phones and computers, programmable logic devices, gaming systems such as XBOX and PLAYSTATION, and others. Desirably, each reporting computer 104a-c is associated with, directly or indirectly, with systems, assets, facilities or the like (collectively, “facilities”) performing, in whole or in part, at least one given task, such as waste water treatment, data signal processing, air traffic control, home monitoring, or the like. Each reporting computer 104a-c receives information for various systems, subs-systems, assemblies, components, sub-components, parts, procedures, process flows and the like associated with a facility. As described above, such systems, sub-systems e al. are commonly referred to herein as Processes.

Further, each facility can be broken down, for purposes of monitoring, analysis and virtual benchmarking, to practically any level of specificity. For example, a facility can be broken down on a system level (e.g., waste water influent processing), component level, sub-assembly, part, process or other basis. In one embodiment of the present invention, Processes are monitored, analyzed and virtually benchmarked at various levels including the facility as a whole, on a system basis and on a sub-system (i.e., a system within a system) basis. Other embodiments of the present invention may monitor, analyze and virtually benchmark a Process at any desired level(s) of specificity. The reporting of information to and by each reporting computer 104a-c desirably reflects the desired level of specificity for any facility/Process to be monitored.

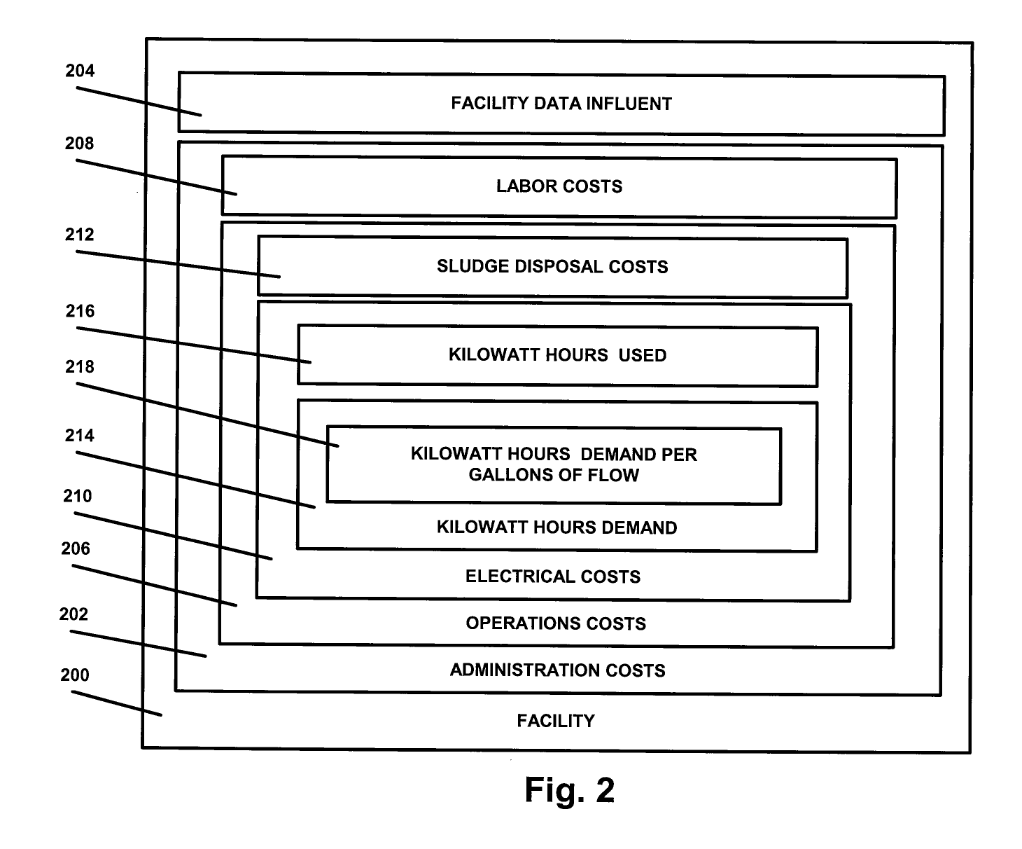

More specifically and as shown in FIG. 2, a facility 200, can be broken down into various levels of specificity (i.e., various Processes) for purposes of monitoring, analysis and virtual benchmarking. For example, a waste water treatment facility can be broken down into system level Processes such as “administration costs” 202, and “facility data influent” 204. It is to be appreciated that many other aspects of such a facility may also be recognized and broken down into ever lower levels of Process specificity. For purposes of discussion only, FIG. 2 illustrates that “administrative costs” 202 can also be broken down into sub-systems (or classifications) such as: “operations costs” 206 and “labor costs” 208. Similarly, “operations costs” 206 can be broken down further into an even lower level of specificity (or abstraction) such as “electrical costs” 210 and “sludge disposal costs” 212. Yet, “electrical costs” 210 can be further broken down so that one can monitor, analyze and virtually benchmark “kilowatt hours demand” 214 and “kilowatt hours used” 216. Further, the “kilowatt hours demand” 214 can be further abstracted into “kilowatt hours demand per gallons of flow” 218 and the like. Clearly, such specificity can continue until a desired level of monitoring occurs for a given Process. For some processes, such a integrated circuits and nanotechnology, such levels of specificity may even result in monitoring of Processes at the sub-atomic or perhaps even quantum levels. Thus, it should be appreciated that the various embodiments of the present invention facilitate the monitoring, analysis and virtual benchmarking of a Process at any desired level of specificity.

To facilitate the monitoring, analysis and virtual benchmarking of Processes at various levels of specificity, the various embodiments of the present invention use a system such as the one illustrated in FIG. 1 to connect each reporting computer 104a-c to a server 106, which is operably connected to database 108. As each reporting computer 104a-cperiodically reports information concerning the operation and performance of each of their respective facilities, the reported information is stored in the database 108. It is to be appreciated that each reporting computer 104a-c can be configured, as desired, to provide actual costs, estimated costs, allocated costs and/or the like to the server 106. The stored information is utilized by the server 106 to determine the optimum performance achievable at a given level of specificity for a virtual facility having a given set of properties and/or characteristics.

Regarding the server 106, any suitable computing device can be utilized. Various embodiments of the present invention may require greater or lesser computing power in a given server or servers. Thus, it is to be appreciated that the system can be scaled and configured to fit the desired implementation.

Similarly, the database 108 is not to be construed as being limited to any single storage medium(s) and can be configured to utilize any and all local and/or distributed storage mediums available or to become available. Examples of storage technologies which can be utilized with the present invention to store any desired information, and which are well known in the art, include, but are not limited to, magnetic, electrical, optical, electro-magnetic, biological, plasma and others. Also, the database 108 can be configured to be compatible with various storage systems and/or methodologies, such as those provided by Oracle Corporation, International Business Machines, Microsoft Corporation, Dell, Maxtor, Sun and others.

In one embodiment of the present invention, the database 108 is configured using the Structured Query Language (“SQL”). Further, the database is desirably structured into a matrix, wherein each object in a given cell of each matrix is of a particular data type and of a particular data field. For example, a matrix for a waste water treatment facility might include the following categories in a matrix for use in categorizing and classifying influent flow to a treatment facility:

TABLE 1

| Facility | Influent | Influent | Influent |
|---|---|---|---|
| No. | Flow mgd | TSS mg/L | VSS mg/L |
| 0001 | 000551 | 0013350 | 011750 |
| 0002 | 000250 | 000175 | 019000 |
| 0003 | 001700 | 000900 | 110000 |
| 0004 | 001200 | 000150 | 011500 |

For example, each of the data fields above are desirably specified in the database as the data type of “integer” and each field desirably has a field width of six integers. Similarly, the database might use another matrix or relationship to classify the operations and maintenance costs for a Process and use information from Table 1 to monitor a Process or facility at a desired level of specificity, such as kilowatt hours per gallons of flow. Such a relationship might be as follows:

TABLE 2

| | | | Kilowatt Hrs/ |
|---|---|---|---|
| Facility No. | Electrical Costs | Kilowatt Hours | Gallons of Flow |
| 0001 | $100,000 | 1000 | Calculated from |
| | | | Table 2 Kilowatt |
| | | | hours divided by |
| | | | Table 1 Influent |
| | | | flow |
| 0002 | $500,000 | 2000 | Calculated |
| 0003 | $200,000 | 1700 | Calculated |
| 0004 | $75,000 | 1200 | Calculated |

As shown by the example above, Table 2 utilizes the same facility indicators as Table 1, thereby creating a cross relationship between the tables, such that a composite representation of a Process can be generated and/or reported, while also facilitating the comparison of Processes/facilities at a common level of specificity. Further, relationships between levels of specificity can also be used to compare derived parameters, such as “Kilowatt Hours per Gallons of Flow.” One of skill in the art should appreciate that additional and/or alternative tables may be used to further define and classify parameters provided to the database 108 for use in monitoring, analyzing and generating a VBP for a given Process.

Further, to support the virtual benchmarking of Processes, in specific categories (such as on a sub-system, sub-process or component level) the various embodiments of the present invention desirably utilize a numbering scheme which identifies like components in other facilities. One example of this numbering scheme is 100.20.M05 (wastewater treatment.Influent.NH3N). By specifying Processes at a high degree of specificity in the database and by periodically reporting results and/or usage of such components, the server can utilize such information to generate a virtual benchmark, which when compared to an AP can be used to generate conclusions about the performance of a facility and of a given Process relative to actual industry results, and relative to optimized industry results - as specified by a virtual benchmark.

More specifically, a numbering scheme can be used in conjunction with the various embodiments of the present invention to describe and/or characterize costs and/or other parameters associated with a facility, or other Process, at any desired level of specificity. For example and as shown below in Table 3, a numbering scheme can be configured to utilize a general number, such as “100,” to specify a Process at a high level of abstraction, such as at a waster water treatment plant facility level. Additionally, the numbering scheme can further specify a specific process or system within the “100” class facility using a secondary number, such as “20,” which in the table below indicates the sub-system or process refers to “influent.” Further, further specificity can be provided by using a third number, such as “A11” or “A31,” which are indicative of a unit process level O&M costs and maintenance costs, respectively. Further, while not shown in the table below, additional levels of specificity can be provided and identified using additional fourth, fifth, sixth or other levels in a given numbering scheme. Also, it should be appreciated that the numbering scheme can use alphanumeric characters and/or other characters as desired.

TABLE 3

| General | | Specific | Specific | | |
|---|---|---|---|---|---|
| Unit | General Unit | Unit | Unit | Unit | Unit Process |
| Process | Process | Process | Process | Process | Parameter |
| Number | Name | Number | Name | Parameter | Name |
| 100 | WWTP Facil- | 20 | Influent | A11 | Unit Process |
| | ity Data | | | | O&M Cost |
| 100 | WWTP Facil- | 20 | Influent | A21 | Unit Process |
| | ity Data | | | | Labor Cost |
| 100 | WWTP Facil- | 20 | Influent | A31 | Unit Process |
| | ity Data | | | | Maintenance |
| | | | | | Cost |
| 100 | WWTP Facil- | 20 | Influent | A41 | Unit Process |
| | ity Data | | | | Chemical Cost |
| 100 | WWTP Facil- | 20 | Influent | A51 | Unit Process |
| | ity Data | | | | Electrical |
| | | | | | Cost |
| 100 | WWTP Facil- | 20 | Influent | A61 | Unit Process |
| | ity Data | | | | Sludge |
| | | | | | Disposal Cost |
| 100 | WWTP Facil- | 20 | Influent | A71 | Unit Process |
| | ity Data | | | | Miscellaneous |
| | | | | | Cost |
| 100 | WWTP Facil- | 20 | Influent | E11 | Unit Process |
| | ity Data | | | | KwH |
| 100 | WWTP Facil- | 20 | Influent | E21 | Unit Process |
| | ity Data | | | | Kw Demand |

Similarly, a numbering scheme for an embodiment of the present invention can be presented and/or represented using a tree structure as shown below in Table 4. In this structure, unit process parameters can be related to each other by an alphabetic precursor such as “C” in the “CO1 Sludge to Dewatering, gpd” unit process parameter.

TABLE 4

106 Dewatering

51 Vacuum assisted drying bed

C01 Sludge to Dewatering, gpd
C02 Sludge to Dewatering TSS, mg/l
M01 HYD, Loading, gal/m2/Hr
M02 SLD, Loading, lbs./m2/hr
M03 Poly, lbs/Ton
M04 Dewatered Sludge, lbs/day
M05 Dewatering Filtrate TSS, mg/l
M06 Number of Units on Line
M07 Filtrate, gpd
P01 Tss, Cap %
P02 Cake Conc, %

As shown in Table 5, a numbering scheme can be utilized which distinguishes between provided parameter values, such as “All Unit Process O&M Cost” or “A21 Unit Process Labor Cost,” and derived or calculated parameter values, such as “A12 Facility O&M Cost/mg” or A13 Unit Process O&M cost/mg.” That is, the numbering scheme can be used to represent also represent or identify a calculation or derivation utilized to obtain a given parameter value while also identifying the basis or source for the calculation.

TABLE 5

| Facility Data - | | | |
|---|---|---|---|
| Administration | | Every Unit Process | |
| UPP | Parameter | UPP | Parameter |
| A10 | Facility O&M Cost | A11 | Unit Process O&M Cost |
| A20 | Facility Labor Cost | A21 | Unit Process Labor Cost |
| A30 | Facility Maintenance | A31 | Unit Process Maintenance |
| | Cost | | Cost |

| Facility Data - | | | |
|---|---|---|---|
| Administration | | Every Unit Process | |
| Virtual | Calculated | Virtual | Calculated |
| UPP | Parameter | UPP | Parameter |
| A12 | Facility O&M Cost/mg | A13 | Unit Process O&M Cost/mg |
| A22 | Facility Labor Cost/mg | A23 | Unit Process Labor Cost/mg |
| A32 | Facility Maintenance | A33 | Unit Process Maintenance |
| | Cost/mg | | Cost/mg |

By further example, assume that each of facilities 104a-c is a wastewater treatment facility. Further assume that each facility 104a-c utilizes the same facility configuration for initially treating influent (i.e., waster water from sewers and storm drain systems) and that each facility reports to the server the KwHours used per month to treat the influent. Under the various embodiments of the present invention, the server can use the information reported to it by each of the reporting computers 104a-c, as desired, to monitor, analyze and/or virtually benchmark the power used by each facility to treat effluents. Benchmarking of costs (and/or other parameters) for a given facility can also occur with respect to the reporting facilities and also with respect to a virtual facility at any VBP level of specificity. The VBP desirably identifies real world achievable results possible for a facility having a given set of properties at a given level of Process specificity. Further, when information is reported at even lower levels of specificity, such as peak demand for KwHours per day, the various embodiments of the present invention can be utilized to further refine and identify the virtual benchmark for facilities satisfying the given set of properties at the given level of specificity. Such specificity might, for example, identify that a virtual facility initially treating influents at night, when electricity costs are lower, is optimized whereas those treating influents during the day are not.

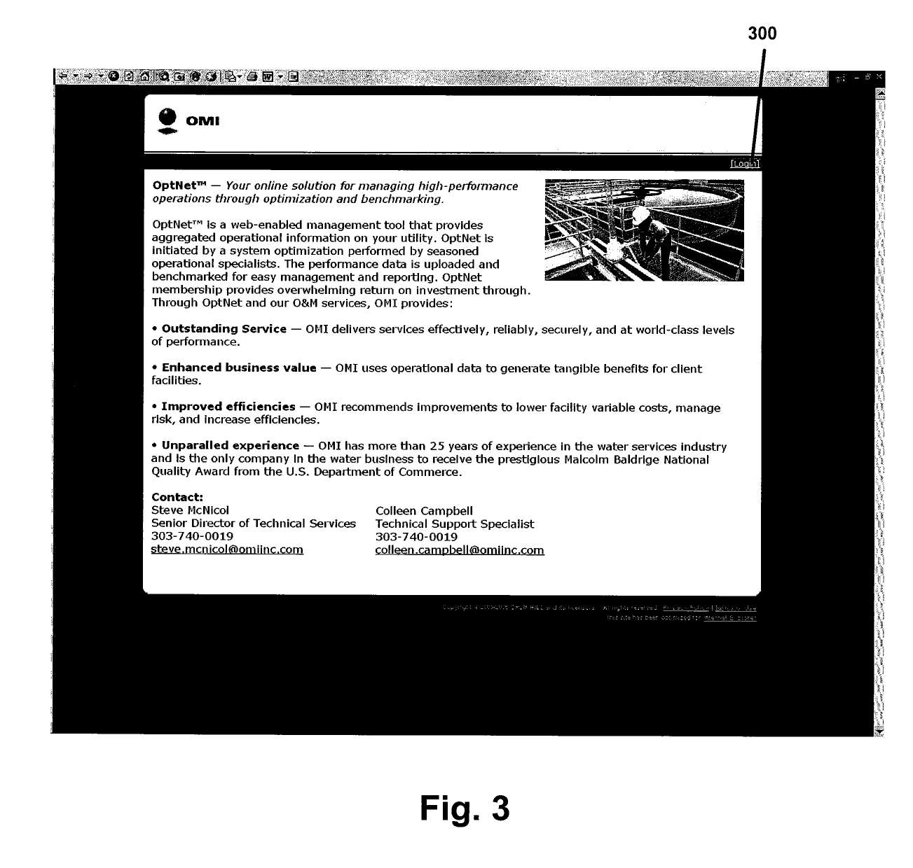

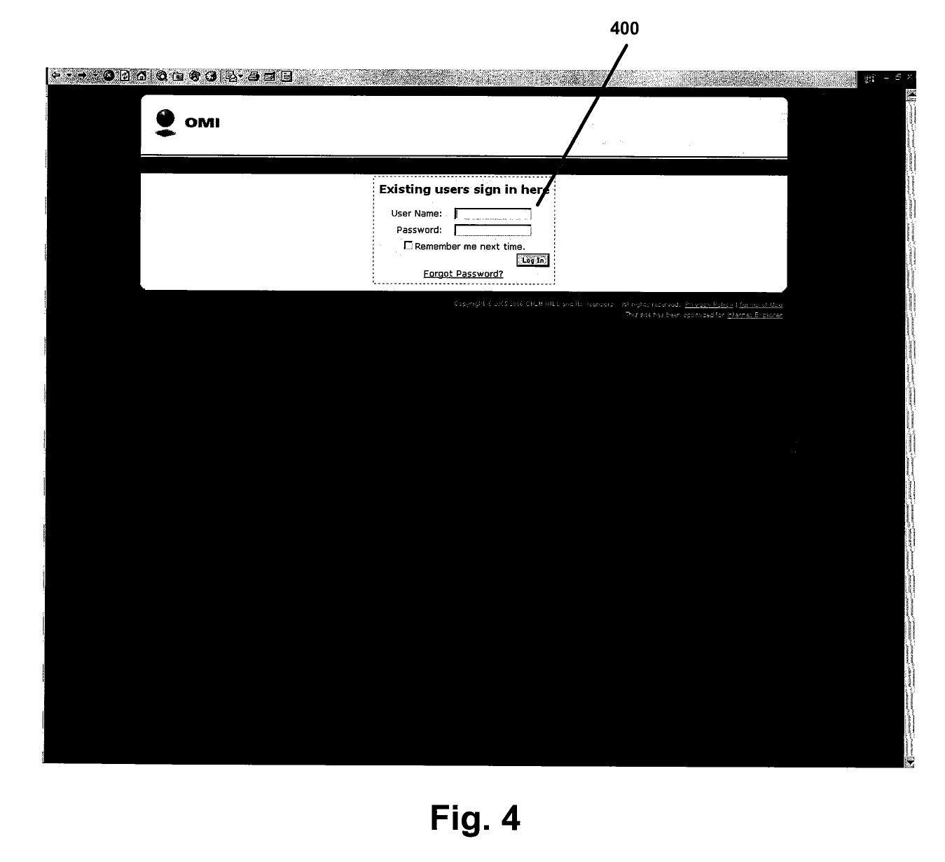

In one embodiment of the present invention, the reporting of a facility's performance characteristics can be accomplished using a web based optimization system such as the OPTNET web based optimization system provided by OMI Inc. of Greenwood Village, Colorado and illustrated in FIG. 3. For this embodiment, an user can log in to the server 106 (FIG. 1) by selecting the “log in” link 300. The user then provides the server 106 with a “user name” and “password” in the appropriate input boxes 400, as shown in FIG. 4. That is, for at least this embodiment, access to the features and functions of a server implementing the virtual benchmarking features of the present invention are secured by a username (such as an e-mail address) and password. It is to be appreciated, however, that access to some or all of the features of a system implementing the present invention may be further secured by the use of various well known data security and/or encryption techniques such as digital certificates, private keys, randomly generated and/or periodically updated secure Ids, biometric indicators and otherwise.

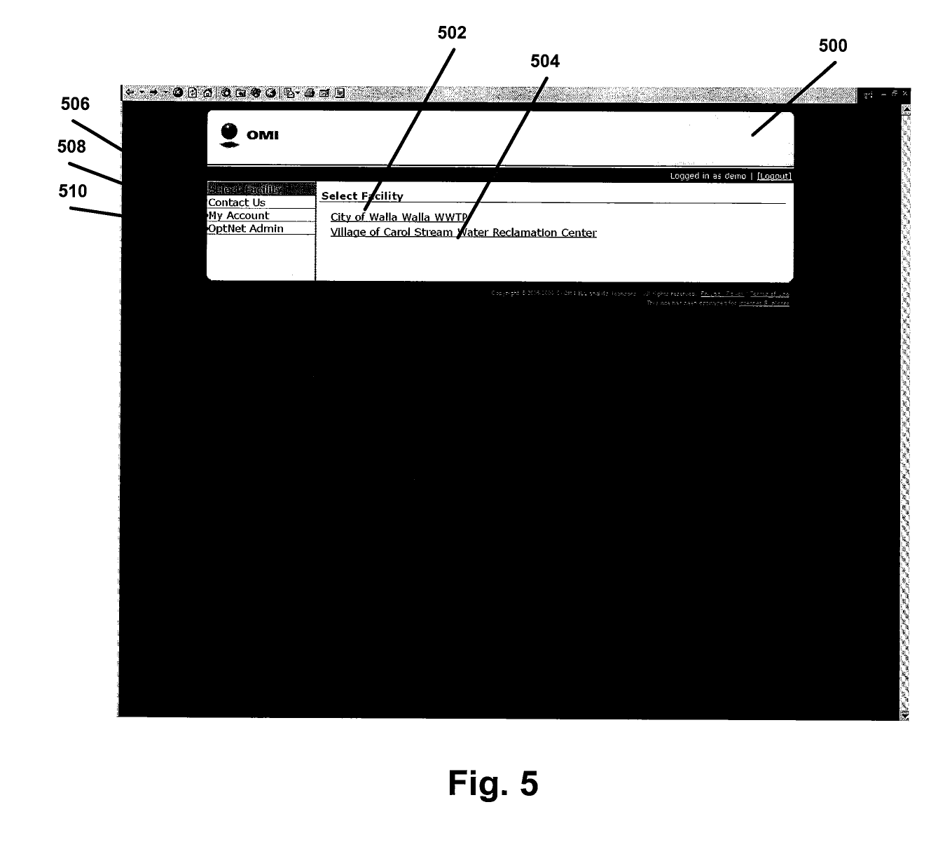

Upon gaining access to the server, the user is then presented with a home page such as the web page 500 shown in FIG. 5. Desirably for at least one embodiment of the present invention, a user may access from the home page 500 each of those facilities 502 and 504 with which they are associated. As shown in FIG. 5, the user has been previously associated with two facilities, the “City of Walla Walla WWTP” 502 and the “Village of Carol Stream Water Reclamation Center” 504. As represented by the underlined names, hyperlinks to web pages providing more information about each of these facilities is provided. Also, it is to be appreciated that any number of facilities may be associated with a user and links to information for such facilities may be populated on the home page 500.

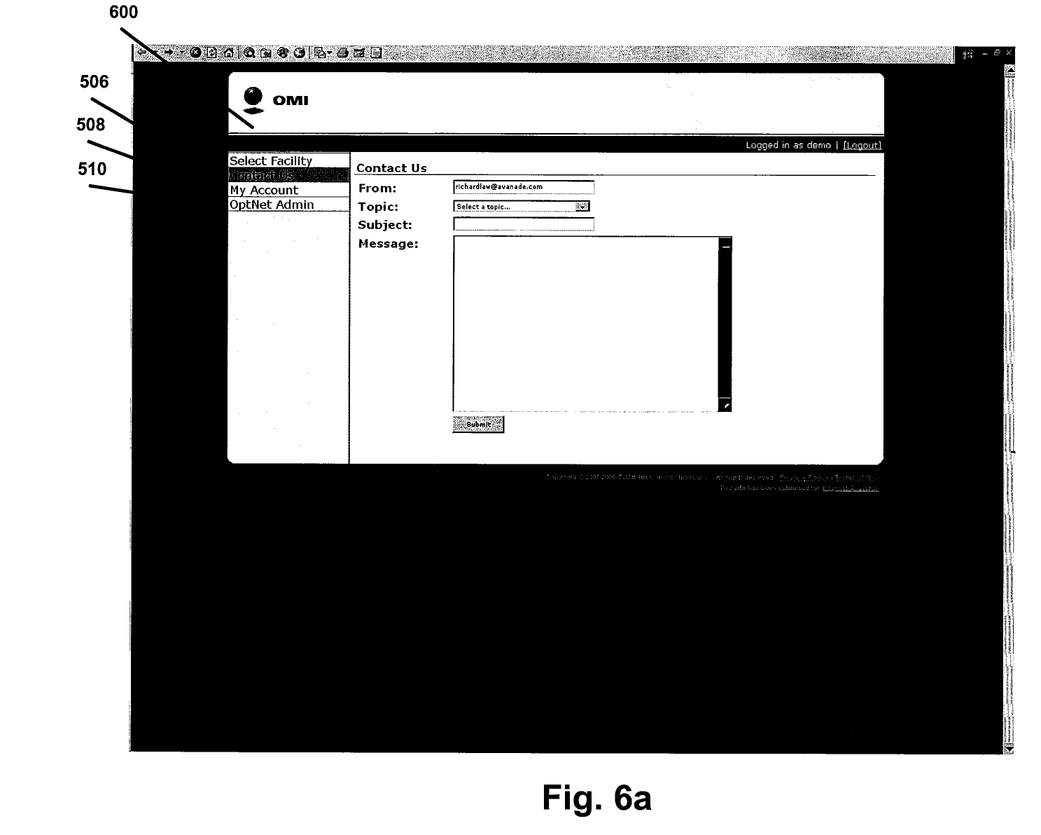

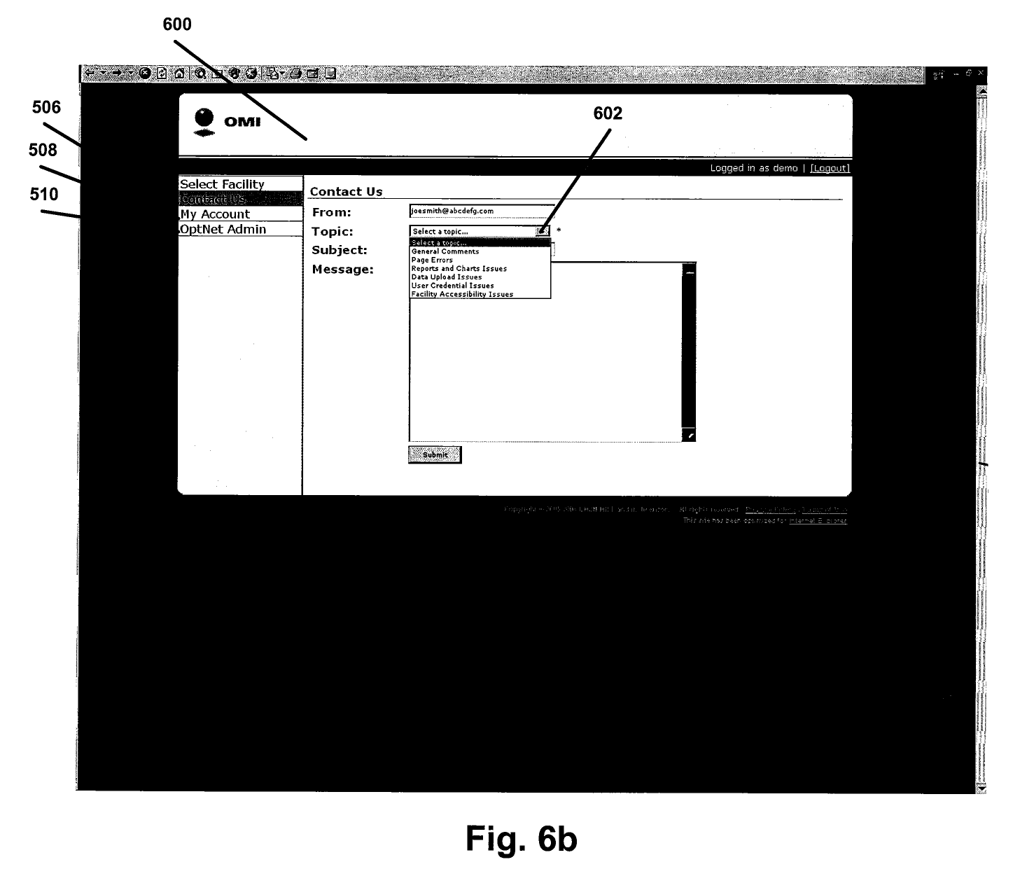

FIG. 5 also provides a variety of links along the left hand side of the page 500. These links include “Contact Us” 506, “My Account” 508 and “OptNet Admin” 510. When the “Contact Us” 506 link is selected, an e-mail web page 600 is presented to the user, as shown in FIGS. 6a -6b. Desirably, a user is provided with the option of selecting a topic from a drop down list 602 (FIG. 6b). The list includes, for example, selections relating to “general comments,” “page errors,” “reports and chart issues,” “data upload issues,” “user credential issues,” and “facility accessibility issues.” Other topics and/or user supplied topics may be supported in other embodiments of the present invention. Likewise, communication with server administrators may also be provided and/or supported by any available communications means including, but not limited to, telephone, voice messages, instant messages, web postings, facsimile, web conferences or the like.

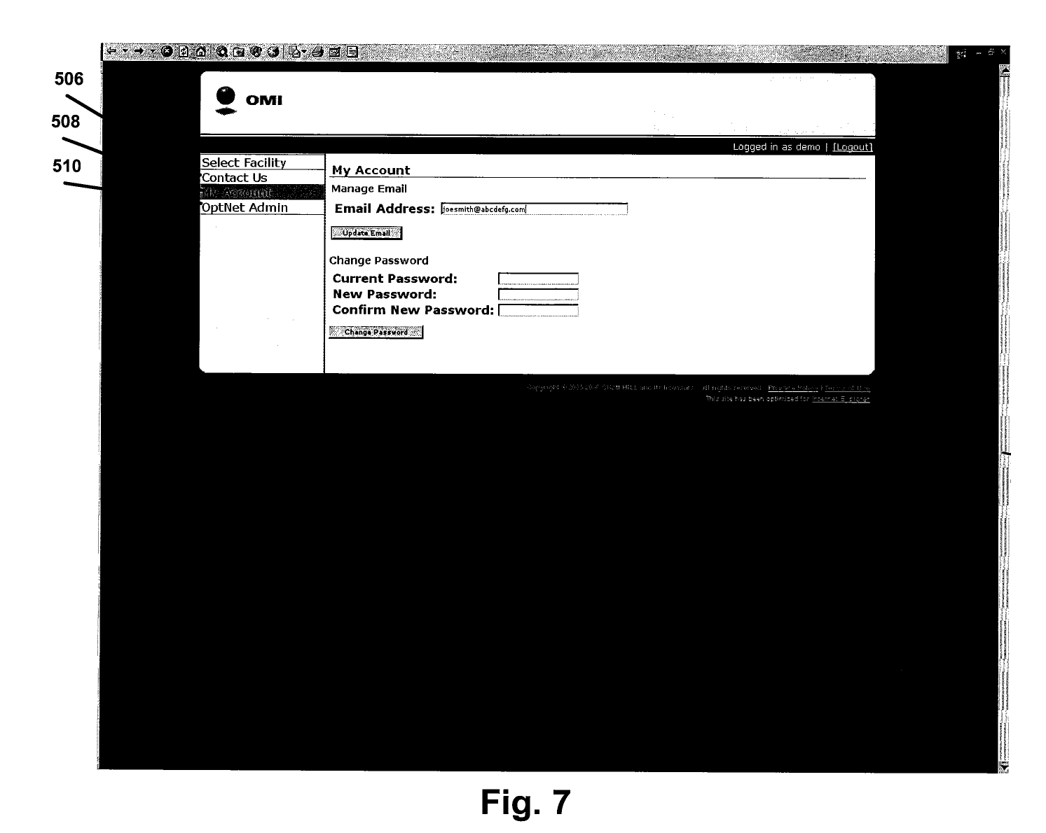

When the “My Account” link 508 is selected, the server presents, for example, a web page 700 (FIG. 7) allowing the user to view and/or change the user's email address and/or password.

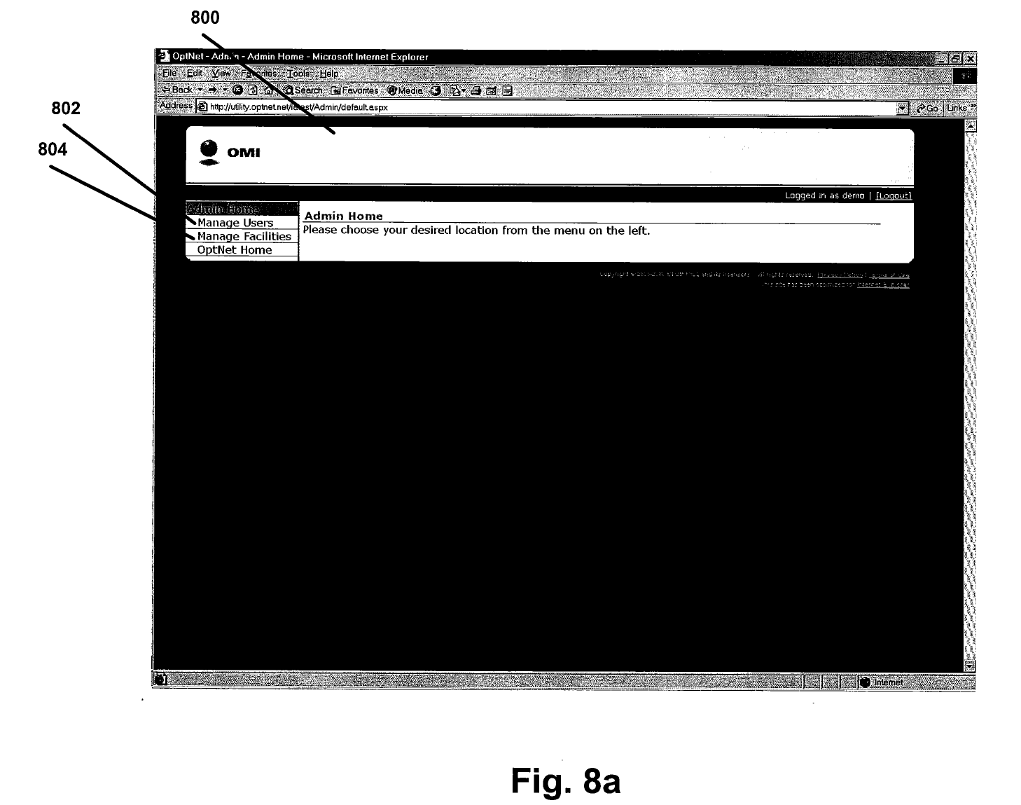

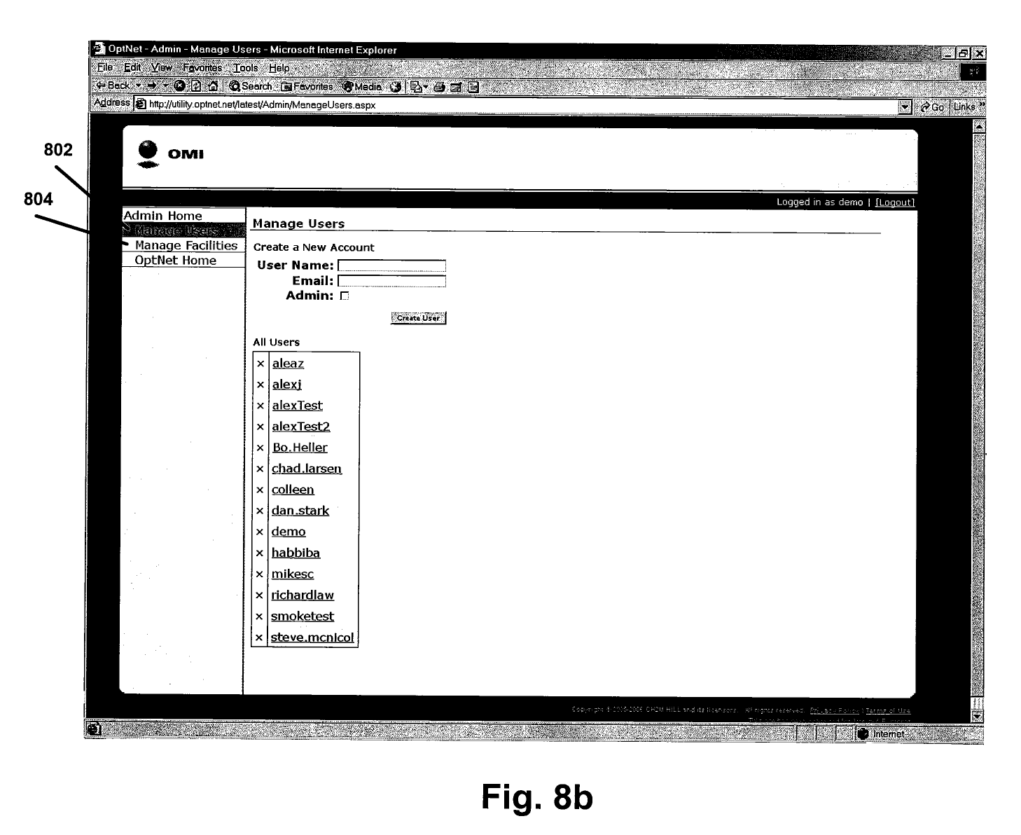

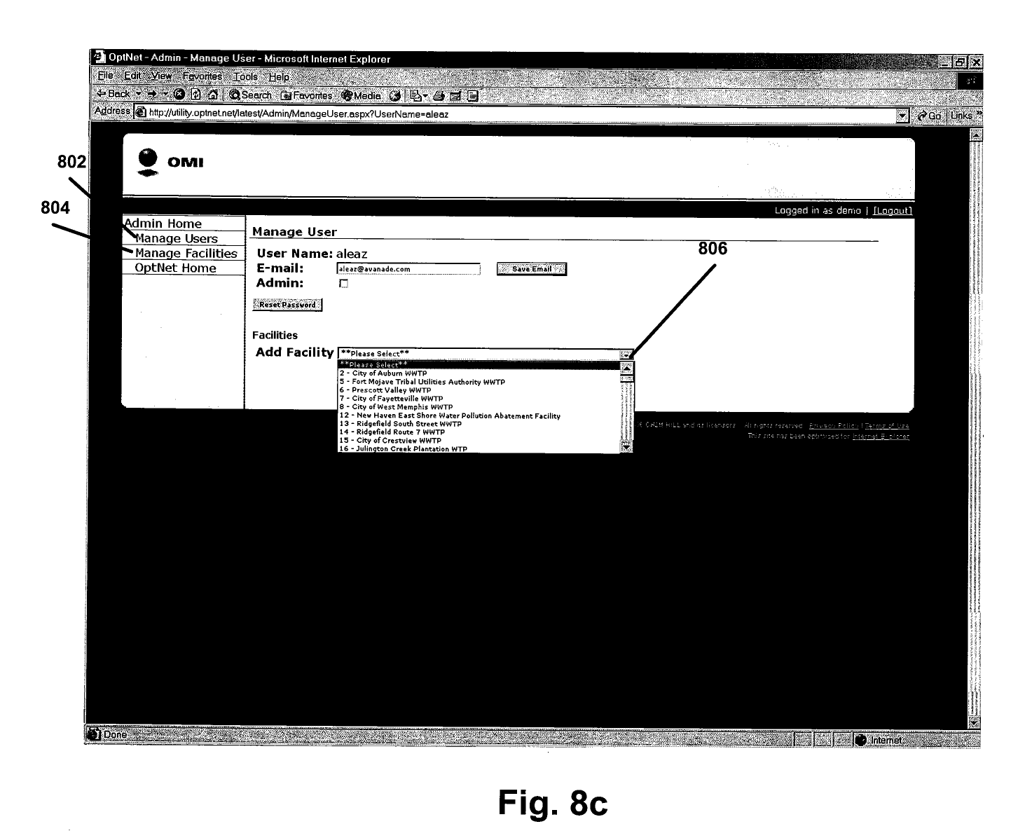

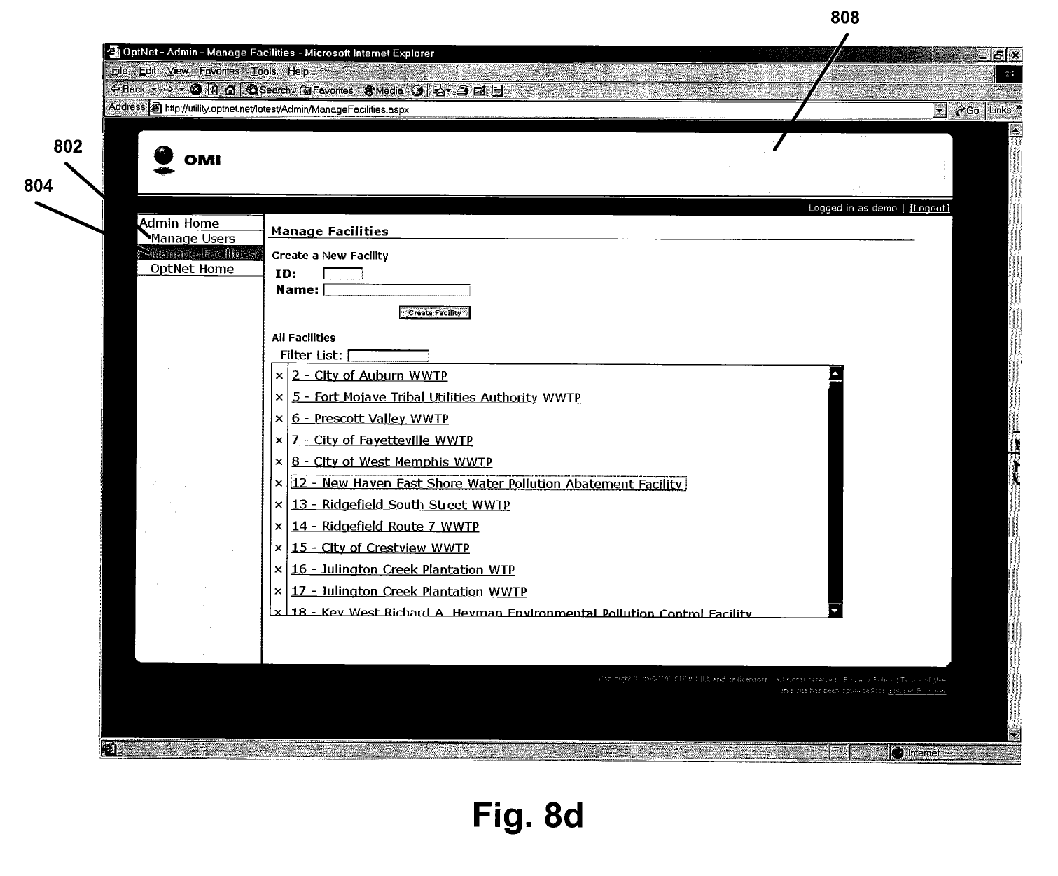

The “OptNet Admin” link 510, when selected, results in the server presenting a web page 800 (FIG. 8a) allowing a user, who has administrative privileges, to select between “Manage Users” 802 and “Manage Facilities” 804 options. When the “Manage User” 802 link is selected, the server presents FIG. 8b, which allows a user with administrative privileges to add, delete and/or modify administrative privileges for other users. Further, each user's name provides a hyper link to a web page by which the administrator may specify for which facilities, if any, a user is to be associated. Such facilities may be shown in a drop down list 806, as shown for example in FIG. 8c.

When the “Manage Facilities” 804 link is selected, the server presents a web page 808 (FIG. 8d) allowing a user, with administrative privileges, to create new facilities and/or select from a listing of existing facilities. By selecting a facility name (which desirably includes a hyper link), the user is then provided access to a web page allowing the user to specify a region (e.g., Northeast, Southeast, Southwest, Northwest) and/or a design capacity for the facility.

In one embodiment, design capacity for a wastewater treatment facility can be expressed over a range of values, such as 0 to 5, 5-10, 15-20, 20-50, 50-100 and >100 gallons per minute. Other ranges, specific values or the like may be used, however, in other embodiments of the system to specify a design capacity of a given Process. For example, an automobile assembly plant might specify its design capacity in terms of cars per hour, whereas a computer system might specify its capacity in terms of Kilobits per second or the like.

The server also can be configured to enable an administrative user to determine which users are associated with a given facility and to add users as desired. It is to be appreciated that a user can also be effectively deleted by not associating them with any facility and/or by changing the user's password and not providing the new password to the user. In other embodiments, users can also be deleted, have limited access privileges and/or otherwise controlled.

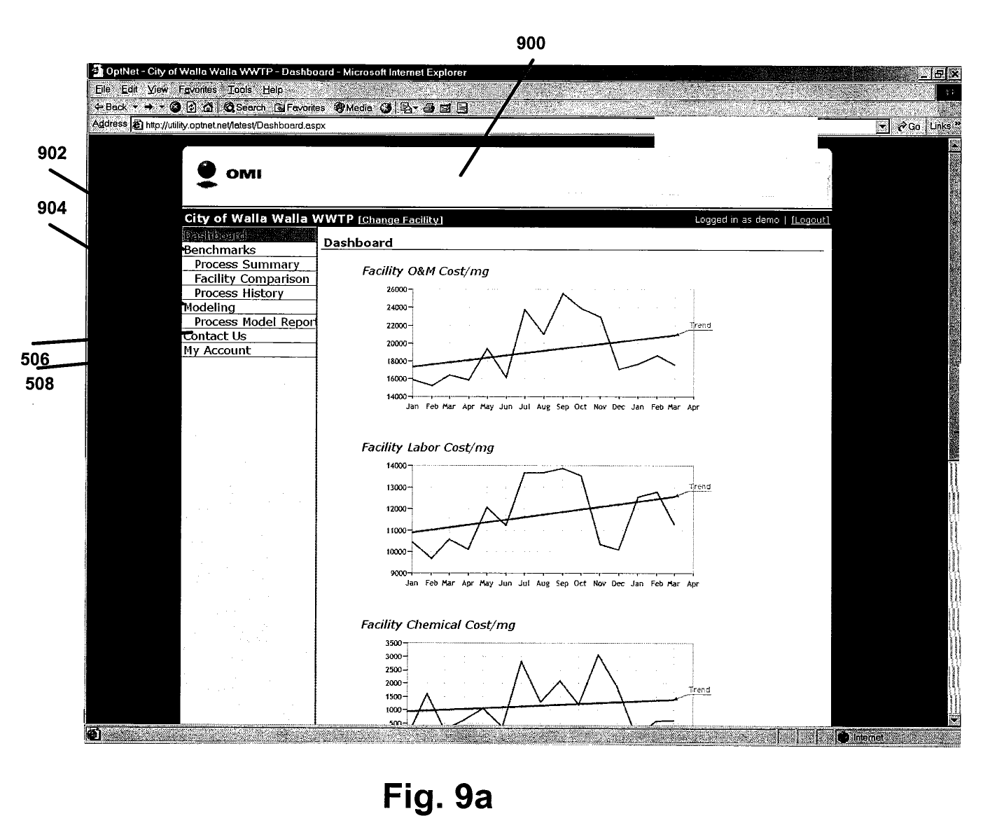

Referring again to FIG. 5, when a facility link such as the link provided to the “City of Walla Walla WWTP” is selected, the server presents a Dashboard 900 page as shown in FIGS. 9a-b.

The Dashboard 900 provides a summary of selected parameters over time. For example, for the waste water treatment facility example depicted in FIGS. 9a-b, the Dashboard presents summary charts depicting the “Facility O&M Cost/mg” (where mg=millions of gallons), labor costs, chemical costs, facility electrical costs and sludge disposal costs. In short, the Dashboard 900 provides a user with a quick, easy to grasp representation of the costs associated with operating the facility on a historical basis and any upward or downward trends in such costs. The server 106 (FIG. 1) generates these charts based upon historical data provided periodically by the reporting computers 104a-c (FIG. 1). Further, in one embodiment, these charts and the underlying data supporting them is generated based upon aggregate data collected and statistically processed by each facility's computer prior to transmission via the Internet (or any other suitable communications medium) to the server 106.

Referring again to FIG. 9a, the Dashboard 900 also includes a plurality of hyper links to other features and functions provided by the server. These include “Benchmarks” 902, “Modeling” 904, and the above discussed “Contact Us” 506 and “My Account” 508 links.

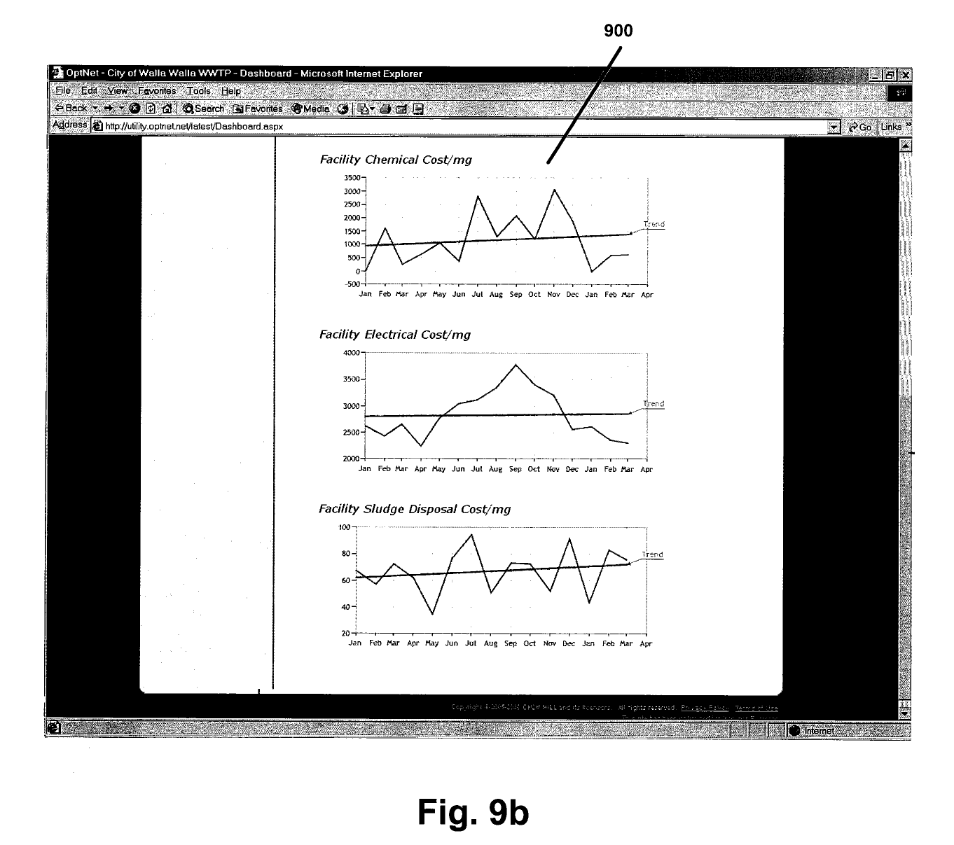

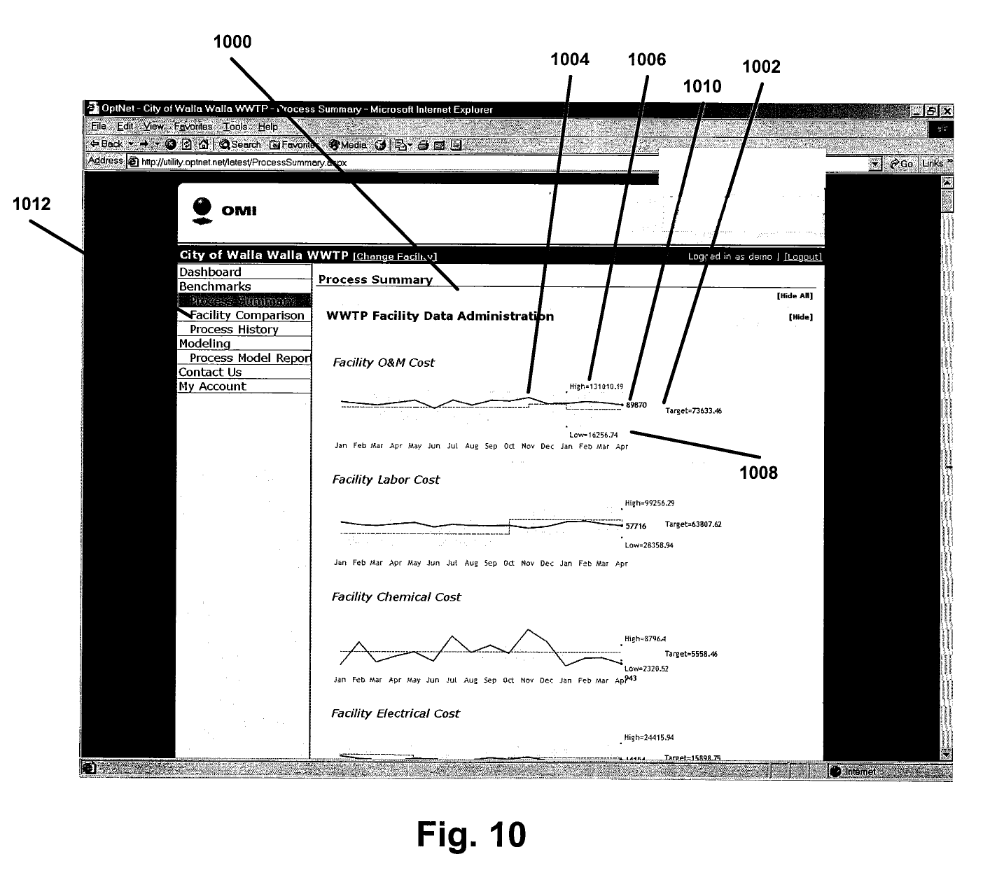

With specific regard to Benchmarks, the system of this present embodiment desirably includes an option to see “Process Summary” information. As shown in FIG. 10, the server desirably processes the information received from the various participating facilities and generates a target or virtual benchmark 1000 for a facility's various systems and components (as reported to the server and stored in the database, and/or as derived from information present in the database). For example, the server 106 can recognize a target value 1002 for a facility's total O&M costs. In another embodiment of the present invention, the target value can be automatically or semi-automatically set and/or determined by the server 106. The server also presents the actual performance 1004 for the facility relative to the target 1002 (which in many instances can be the virtual benchmark), while presenting the high 1006, low 1008, and last 1010 recorded value for the facility in the given category. It is to be appreciated that the “process summary” pages provide to a user a quick, easy to interpret representation of the facility under study's performance relative to a target, such as a virtual benchmark.

As discussed above, the breaking down of a Process (e.g., a facility such as the “City of Walla Walla WWTP”) can be to any level of specificity. With regards to waste water treatment facilities, a representative selection of levels of specificity that a user might desire and a particular embodiment of the present invention might support include those shown in List 1.

List 1

City of Walla Walla WWTP

Administration Data

Operations & Maintenance Costs

O&M Cost/mg
Electrical Costs

Electrical Cost/mg
KwH

KwH/mg

KwH Demand

KwH Demand/mg

Labor Costs

Labor Hours

Labor Hours/mg

Overtime Hours
Sick Leave Hours
Labor Cost/mg
Workmen Compensation Hours

Percent Workmen Comp

Electrical Costs

KwH

KwH/mg

KwH Demand

KwH Demand/mg
Electrical Cost/mg

Chemical Costs

Chemical Cost/mg

Sludge Disposal Costs

Sludge Disposal Cost/mg

Maintenance Costs

Maintenance Costs/mg

Miscellaneous Costs

Miscellaneous Costs/mg

Influent Data

Influent Flow mgd
Influent TSS mg/L
Influent VSS mg/L
Influent BOD mg/L
Influent NH3 mg/L
O&M Costs
Labor Costs
Electrical Costs
Chemical Costs
Sludge Disposal Costs
Maintenance Costs
Miscellaneous Costs

Effluent Data

TSS mg/L
BOD mg/L
NH3 mg/L
NO3 mg/L
O&M Costs
Labor Costs
Electrical Costs
Chemical Costs
Sludge Disposal Costs
Maintenance Costs
Miscellaneous Costs

Screening Fine Screen

Cu. Yds/MG
O&M Costs
Labor Costs
Electrical Costs
Chemical Costs
Sludge Disposal Costs
Maintenance Costs
Miscellaneous Costs

Clarification General

SOR gal/SF/Day
SLR lbs/SF/Day
DT Hrs
Blanket ft
O&M Costs
Labor Costs
Electrical Costs
Chemical Costs
Sludge Disposal Costs
Maintenance Costs
Miscellaneous Costs

Clarification Primary-Center Feed

Sludge Wasted lbs/day
Sludge Flow mgd
SOR gal/SF/Day
SLR lbs/SF/Day
DT/hrs
Blanket ft
Number of Units on Line
TSS Cap %
Sludge Concentration mg/L
O&M Costs
Labor Costs
Electrical Costs
Chemical Costs
Sludge Disposal Costs
Maintenance Costs
Miscellaneous Costs

Clarification Secondary-Center Feed

SOR gal/SF/Day
SLR lbs/SF/Day
DT/hrs
Blanket ft
Number of Units on Line
TSS Cap %
Sludge Concentration mg/L
O&M Costs
Labor Costs
Electrical Costs
Chemical Costs
Sludge Disposal Costs
Maintenance Costs
Miscellaneous Costs

Grit Removal Channel

Cu Yds/MG
O&M Costs
Labor Costs
Electrical Costs
Chemical Costs
Sludge Disposal Costs
Maintenance Costs
Miscellaneous Costs

Thickening GBT-BELT

Feed Sludge Flow gpd
WAS TSS lbs/day
TWAS mg/L
HYD Loading
SLD Loading
Poly lbs/Ton
Filtrate gal/day
Filtrate lbs/day
Filtrate mg/L
Number of Units On Line
TSS Cap %
Sludge Concentration mg/L
O&M Costs
Labor Costs
Electrical Costs
Chemical Costs
Sludge Disposal Costs
Maintenance Costs
Miscellaneous Costs

Dewatering Belt Press

Sludge to Dewatering gpd
Sludge to Dewatering TSS mg/L
Poly Lbs/Ton
Dewatered Sludge lbs/day
Dewatering Filtrate TSS mg/L
Number of Units On Line
TSS Cap %
Cake Concentration %
O&M Costs
Labor Costs
Electrical Costs
Chemical Costs
Sludge Disposal Costs
Maintenance Costs
Miscellaneous Costs

Dewatering Drying Bed

Number of Units On Line
O&M Costs
Labor Costs
Electrical Costs
Chemical Costs
Sludge Disposal Costs
Maintenance Costs
Miscellaneous Costs

Sludge Disposal Land Application

Tons/Day
Loading Tons/Acre
Hauling Efficiency
O&M Costs
Labor Costs
Electrical Costs
Chemical Costs
Sludge Disposal Costs
Maintenance Costs
Miscellaneous Costs

Activated Sludge General

Number of Units On Line
O&M Costs
Labor Costs
Electrical Costs
Chemical Costs
Sludge Disposal Costs
Maintenance Costs
Miscellaneous Costs

Activated Sludge Oxidation Ditch, Carousel

WAS Flow
Aerial Tank Inventory lbs
RAS Flow
MLSS mg/L
HRT Hrs.
Sludge Yield lb/lb
F/M lb/lb
SRT Days
MVLSS mg/L
WAS TSS mg/L
Number of Units On Line
SVI ml/g
Efficiency % Removal
O&M Costs
Labor Costs
Electrical Costs
Chemical Costs
Sludge Disposal Costs
Maintenance Costs
Miscellaneous Costs

Attached Growth Trickling Filter

Recy. Flow mgd
Recy Ratio %
Org. Load lb/sf/day
Wet. Rate g/sf/day
DO mg/L
Number of Units On Line
Efficiency % Removal
O&M Costs
Labor Costs
Electrical Costs
Chemical Costs
Sludge Disposal Costs
Maintenance Costs
Miscellaneous Costs

Sludge Stabilization Anaerobic Digestion

HRT Hrs.
VA/Alkaline Ratio
Number of Units On Line
Number of 2^{nd} Stage Units On Line
VS Reduction %
O&M Costs
Labor Costs
Electrical Costs
Chemical Costs
Sludge Disposal Costs
Maintenance Costs
Miscellaneous Costs

Disinfection Sodium Hypochlorite

Number of Units On Line
No. of Coli form Violations
Residual mg/L
O&M Costs
Labor Costs
Electrical Costs
Chemical Costs
Sludge Disposal Costs
Maintenance Costs
Miscellaneous Costs

Dechlorination Sodium Bisulfite

Number of Units On Line
No. of Residual Violations
Dose Ratio
O&M Costs
Labor Costs
Electrical Costs
Chemical Costs
Sludge Disposal Costs
Maintenance Costs
Miscellaneous Costs

Further, it is to be appreciated that while the server supports the virtual benchmarking (in at least one embodiment) of the above parameters on what is essentially a subsystem level, each facilities' reporting computer 104a-c similarly support the collection, aggregation (as desired) and communication of each of these parameters to the server on a periodic or as otherwise specified basis. Based upon the collection of subsystem level information from a plurality of facilities the server can calculate and determine a virtual benchmark that a facility, under analysis, should desirably achieve.

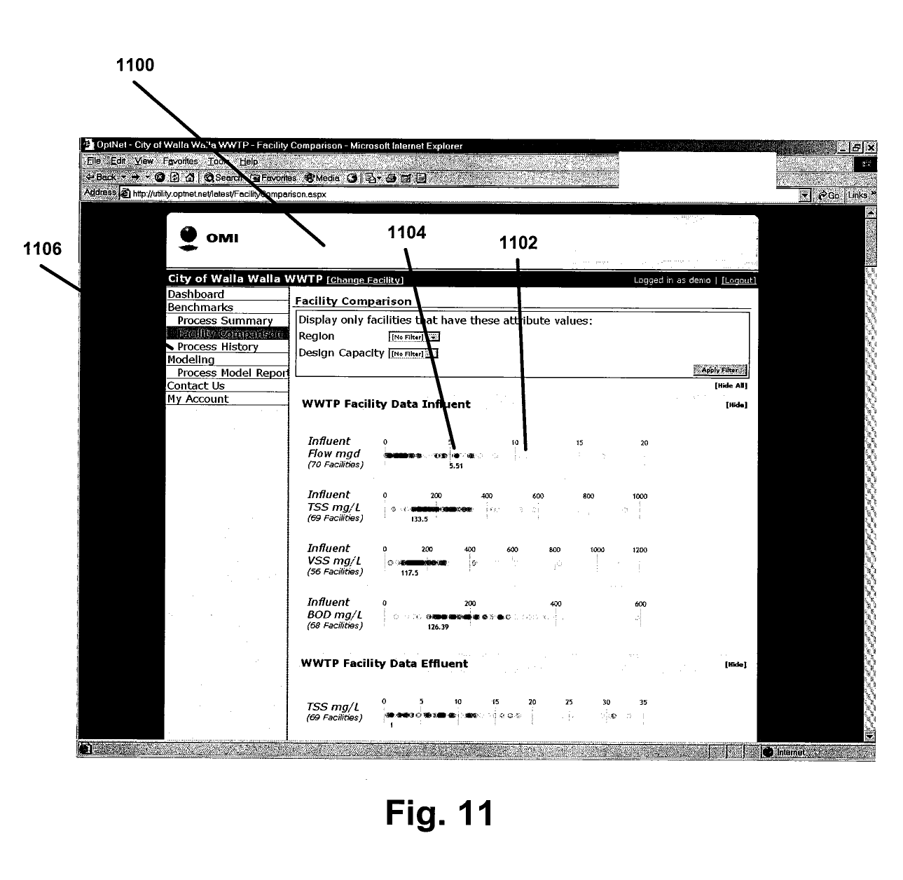

Referring again to FIG. 10, the server also provides a “Facility Comparison” 1012 link. When this link is selected, a web page 1100 providing a comparison of the selected facility with other like facilities is presented, as shown in FIG. 11. In FIG. 11, each facility that is within the specified sample and has provided information in a specified category (e.g., “Influent Flow mg/d”) is identified by an oval 1102. As the number of responding facilities reports a given aggregate value, over a given time period, the ovals at such value correspondingly darken. Thus, the darkness of an oval, at any given value, corresponds to the number of facilities reporting the same result. As applied to the category “Influent Flow mg/d,” FIG. 11 shows that the vast majority of reporting facilities have influent flows of approximately less than 2 mgd. In contrast, only one (or a few) sites have influent flows in the range of 15-20 mgd.

Also, the server identifies the facility under study by separately identifying the reported value (i.e., the “5.51” 1104 indicated in FIG. 11). Thus, it should be appreciated that the server, as expressed by the representation set forth in FIG. 11, provides a “facility comparison” feature which enables a user to gauge their facility's performance vis-a-vis all other reporting facilities for a given level of specificity. Further, the “Facility Comparison” feature of the present invention enables a user to view comparable performance characteristics for their facility in a multiple categories via one presentation.

Additionally, the server can present the user with the option of filtering the data used to populate a “Facility Comparison”, for any given level of specificity. In one embodiment, filtering is provided on a “region” and/or a “design capacity” basis. In other embodiments, other filter criteria, if any, can be supported as desired.

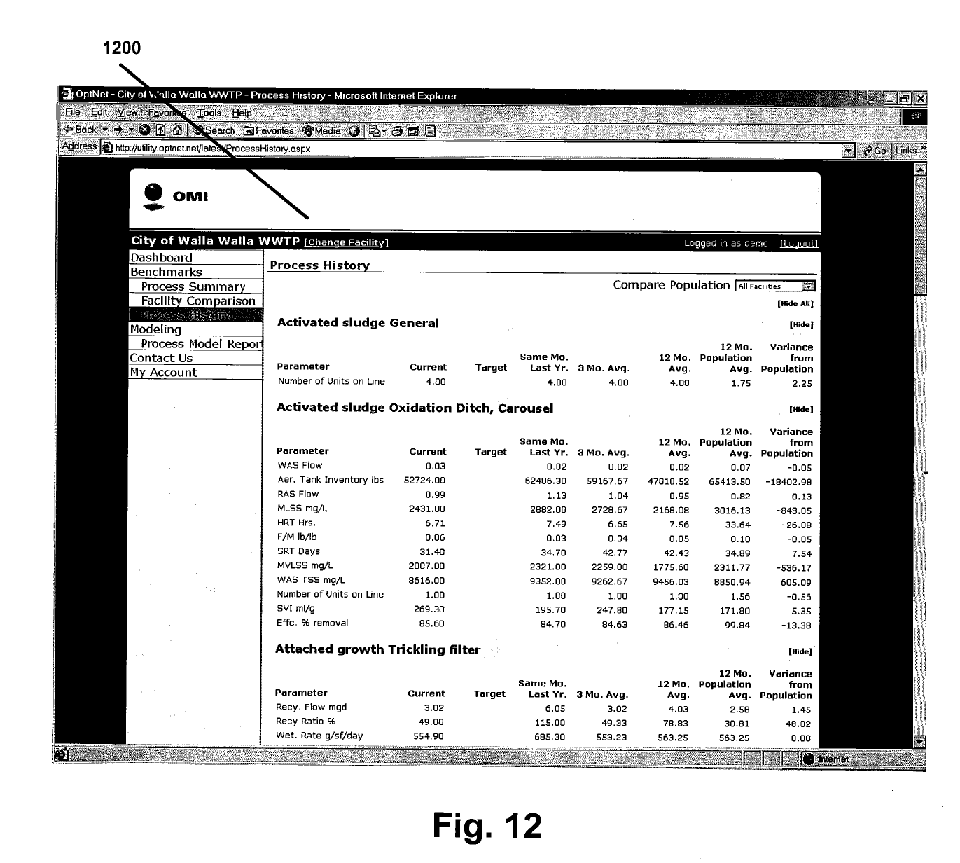

When the “Process History” 1106 link is selected, the server presents a Process History page 1200 as shown in FIG. 12. This page 1200 provides the user with tabular data on a category by category basis. As depicted in FIG. 12, the server can be configured to present information concerning a current reading, a target or virtual benchmark, last year's reading, three month average, twelve month average, the twelve month average for the filtered population (of other comparable facilities) and the facility under studies deviation from the population. Also, this page may be filtered based upon, for example, a percentage of the population of facilities that are within a predetermined range of the facility under study. For example, comparisons can be made with only those other facilities that are within 50% of the facility under study, wherein the comparison in this instance is based upon the flow of waste water through the facility.

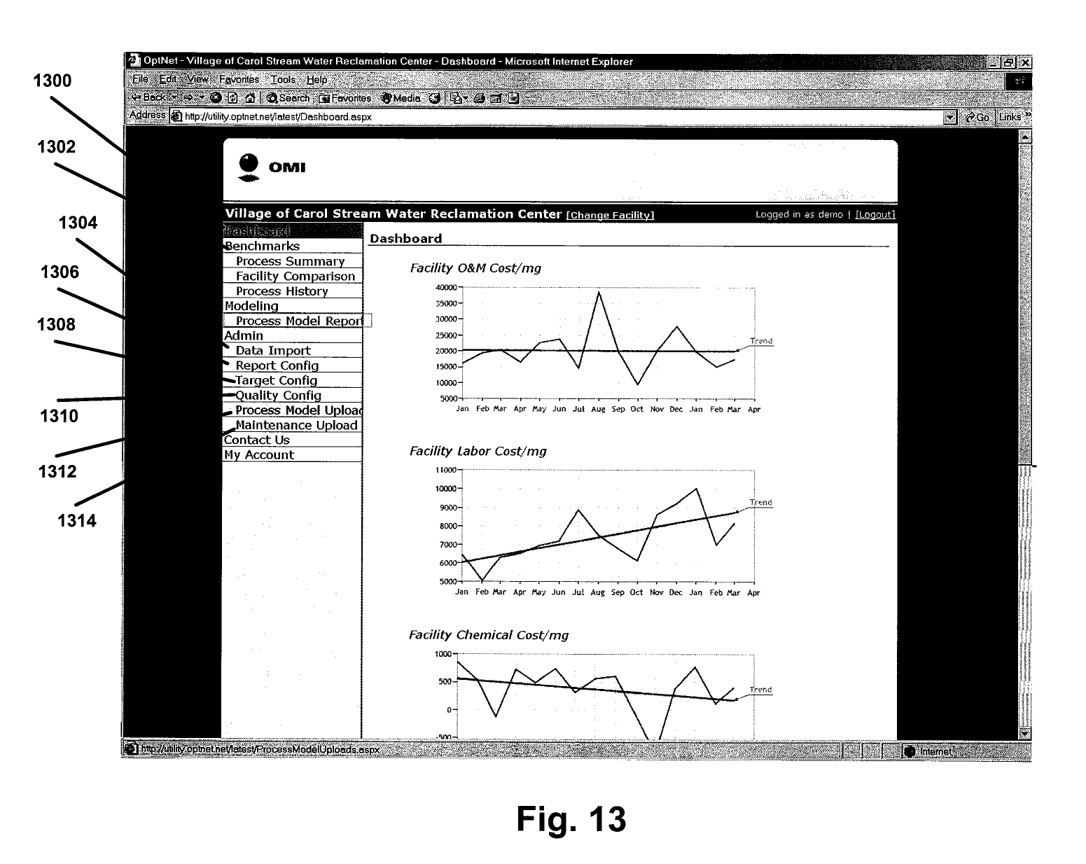

Referring now to FIG. 13, another embodiment of the present invention and the information processing and reporting capabilities of a server is presented with respect to a “Village of Carol Stream Water Reclamation Center” link 504 (FIG. 5). In the embodiment shown in FIG. 13, the server presents a Dashboard 1300 and Benchmark 1302 links. Also, the server presents various administrative features including: importing data 1304; configuring reports 1306, configuring targets 1308, configuring quality settings 1310; uploading process models 1312 and uploading maintenance data 1314.

When the data import link 1304 is selected, the server presents the user with the option of importing monitored data, stored for example on each facilities' reporting computer 104a-c.

For at least one embodiment, this data import occurs using an Excel spreadsheet format.

However, other data import formats can additionally or alternatively be utilized. Also, for at least one embodiment, each facility desirably reports aggregate data to the server and does not report real time or substantially real time readings obtained from the one or more Processes associated with a given facility. While at least one embodiment the present invention can be configured to support real time data monitoring of a facility's Processes, non-real time, aggregated data based monitoring is sufficient for most implementations to accomplish and facilitate the monitoring, analysis and virtual benchmarking of a give facility's Process to a VBP.

Further, upon receipt of information from any reporting computer 104a-c, the server validates the received information. Validation can occur at various degrees of particularity. For example, in one embodiment, validation can simply involve verifying that the received information is provided in the proper format, for example, as an EXCEL spreadsheet or, for maintenance data, in the computerized maintenance management system (“CMMS”) program. More particularly, validation can also include verifying that the information is of the proper size and characteristic, for example, influent data being provided as an integer value of six characters.

Even more particularly, validation can include verifying that the information, for a particular category of information is within predefined limits. For example, a valid temperature reading can be specified in the database as being within 0-50° C. When a value exceeding this range is received the server can be configured to issue appropriate error messages to the responsible reporting computer 104a-c.

Similarly, validation can include alarm monitoring of received information. For example, the server can be configured to trigger an alarm when a parameter exceeds a preset high or low warning value. Various warning stages can also be configured so that a parameter exceeding a first warning level might trigger a web message, whereas a parameter exceeding a critical warning level results in an alarm message of greater urgency, such as, one sent via mobile phone to a designated recipient(s). Thus, it is to be appreciated that servers for the various embodiments of the present invention can be configured to receive and validate information provided by reporting computers and that appropriate actions in response to such validation can be preprogrammed to occur. In another embodiment, alarm monitoring can be based upon historical analysis, actual analysis and/or virtual benchmarking.

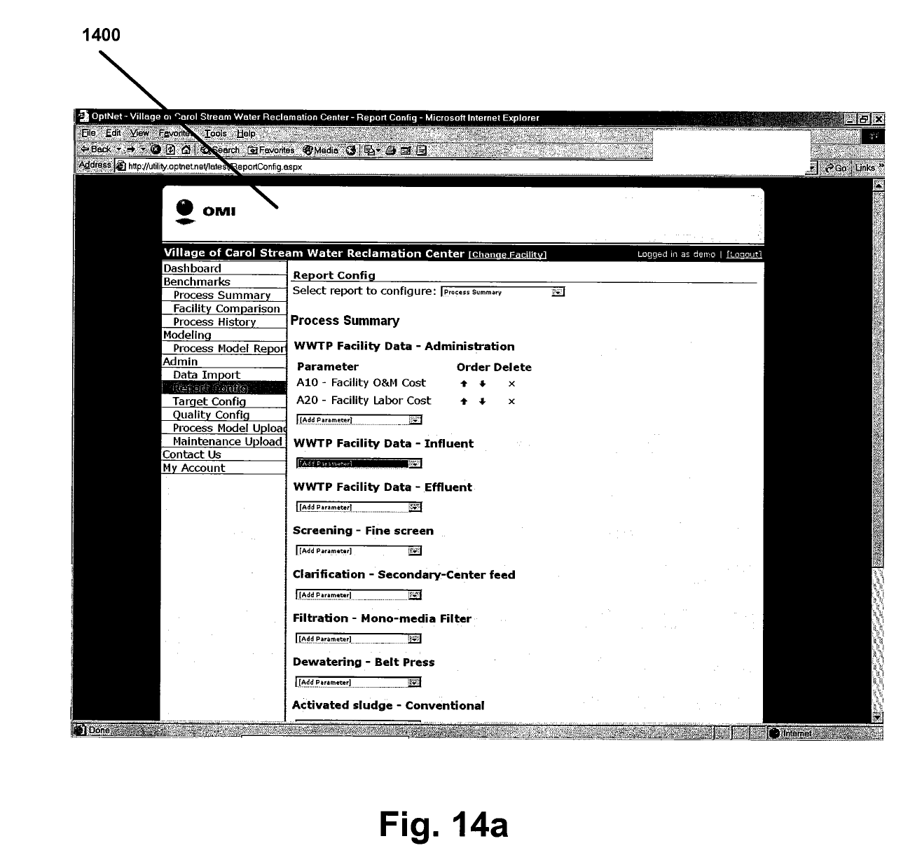

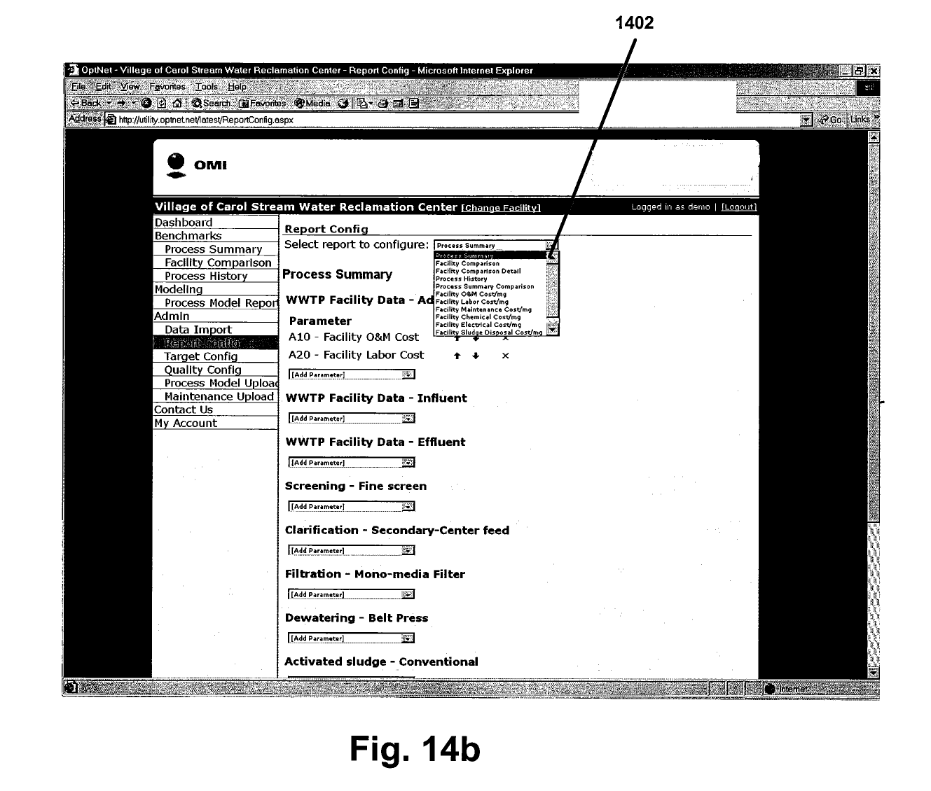

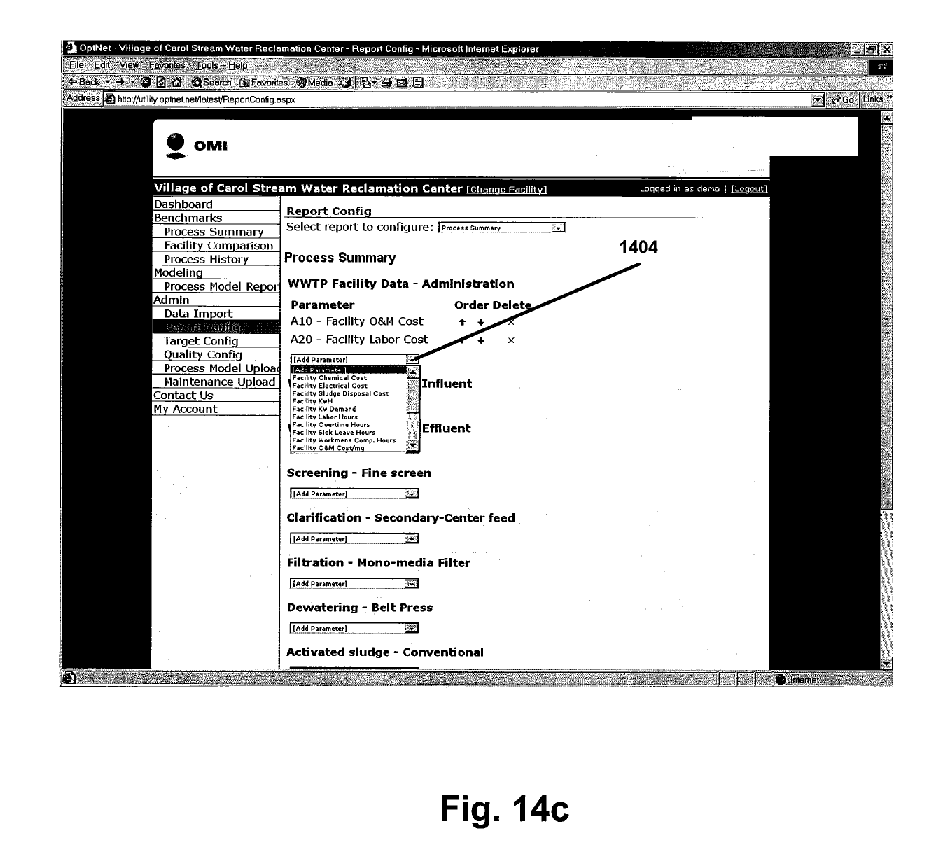

Referring again to FIG. 13, when the “Report Config.” 1306 link is selected, the server desirably presents one or more active web pages which enable the user to configure the various reports. For example, a web page 1400 facilitating such functionality can be presented, as shown in FIG. 14a. More specifically and as shown in FIG. 14b, the server enables the user to select which report to configure via a drop down box 1402. Similarly, the reports may be configured on a component by component basis and/or at an other desired level of specificity by selecting a configuration option, such as those provided by drop down box 1404, as shown in FIG. 14c.

Similarly, upon selection of the “Target Config” link 1308 (FIG. 13), the server presents to the user a web page 1500, as shown in FIG. 15. As discussed above, the various embodiments of the present invention can be configured to enable a user to specify target values, maximum, minimum and warning high and low values for the specified facility for a specified Process. As shown for example in FIG. 15, these values can be specified for any or all of the various categories and sub categories and/or Process associated with a given facility. For at least one embodiment, the server uses these values when populating the tables and charts presented on the before mentioned Benchmark pages and other web pages and reports.

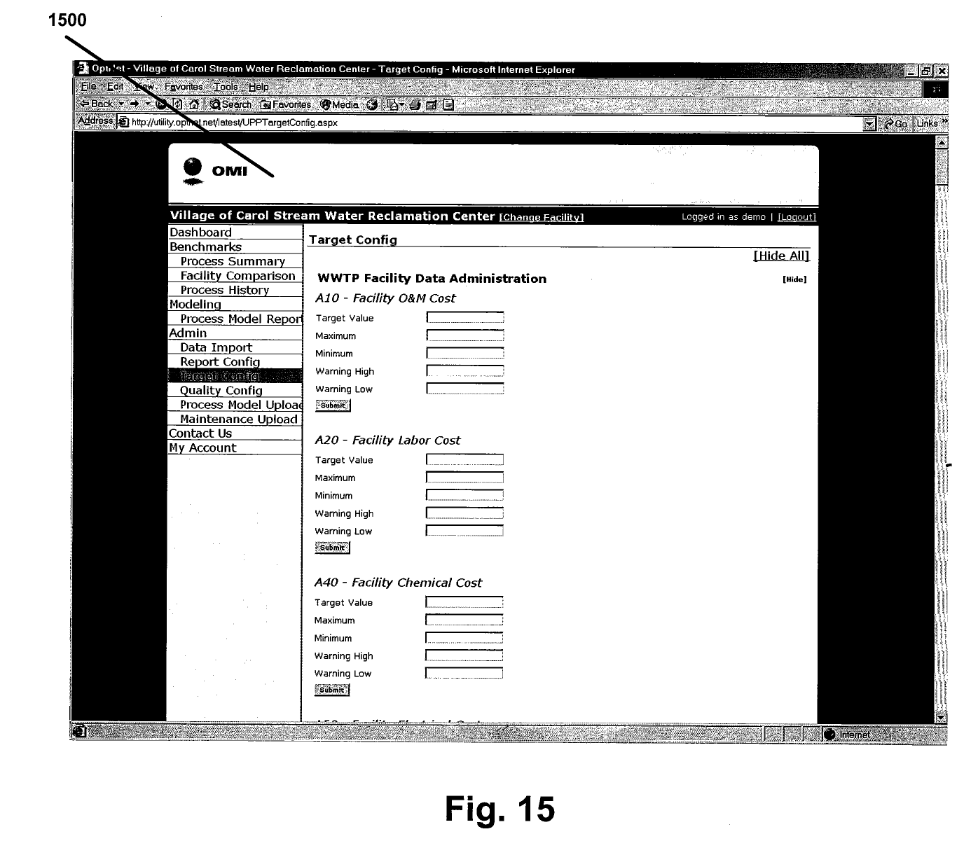

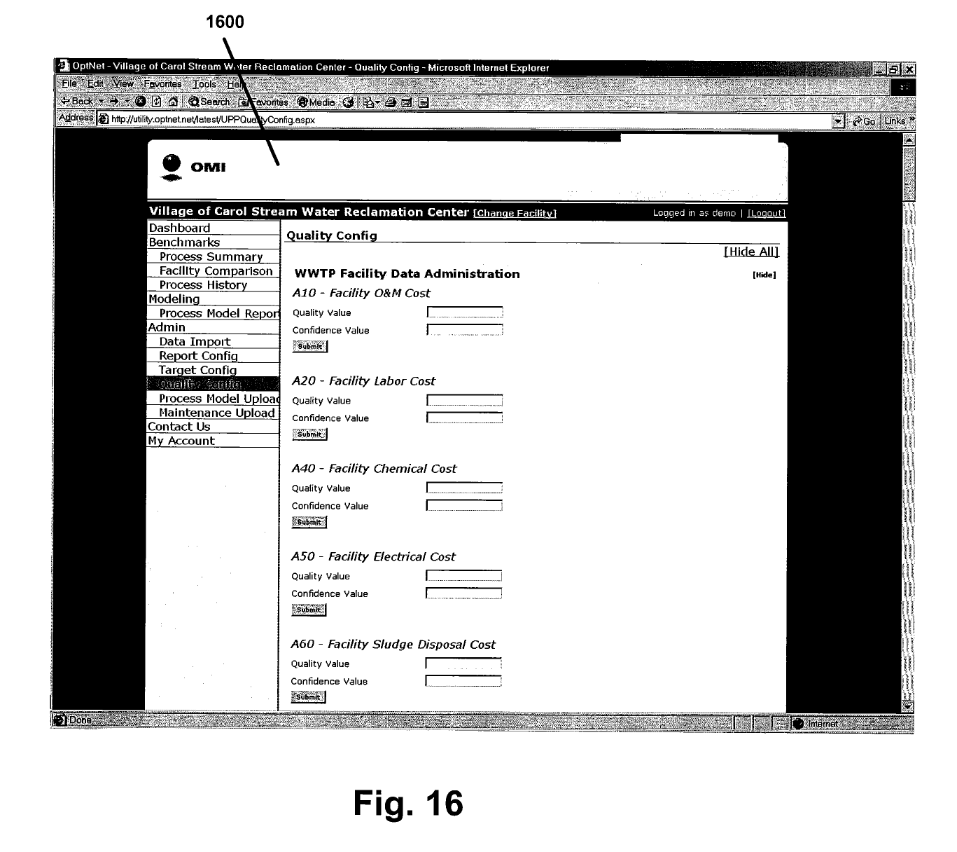

The “Quality Config” link 1310 (FIG. 13), when selected, instructs the server to present a web page 1600, as shown in FIG. 16. More specifically, using this page 1600 a user can specify a quality value and a confidence value for the data being reported. These quality and/or confidence values can be specified for all and/or any given level of specificity.

Quality and confidence values can be used by the server to apply a weight to any reported value, in a specified category or Process, in order to better assess and scale the values contributing to the determination of the virtual benchmark and thereby more accurately determining the value that a virtual benchmark should be set for the given level of specificity of the virtual benchmark.

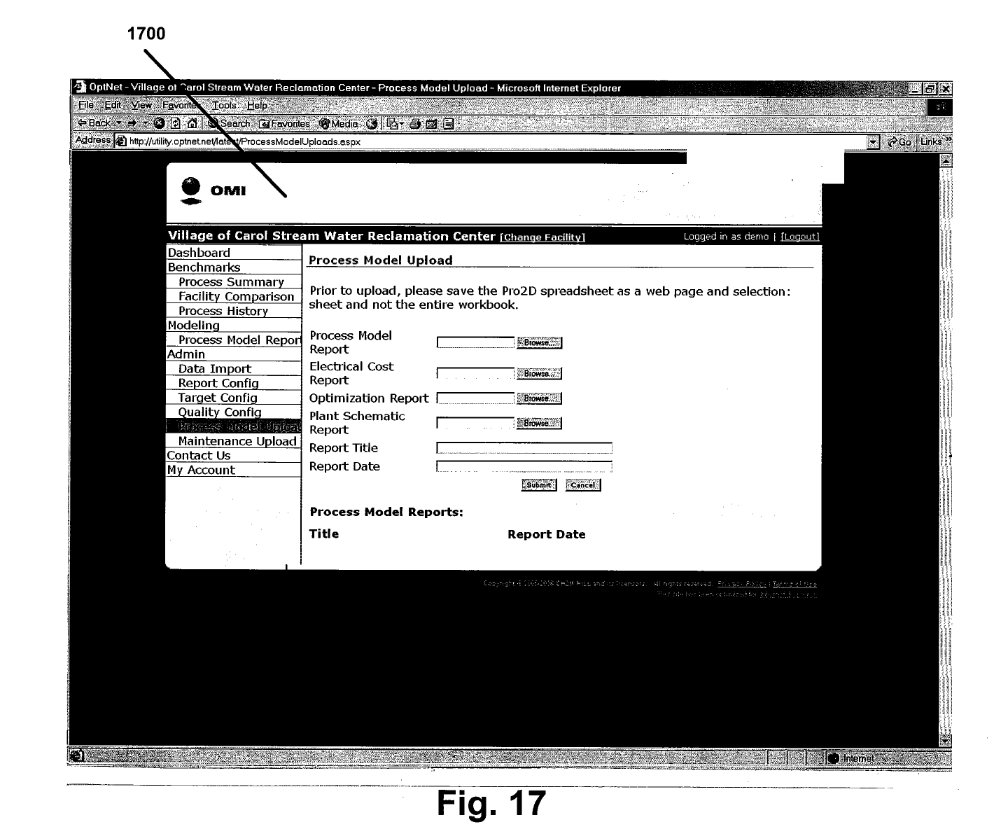

The server can also be configured to provide a user with the option of uploading a process model. As shown in FIG. 17, the server presents to the user a web page 1700 on which the user can select or otherwise specify a process model for use in modeling a given facility.

This process model desirably is compatible with of facility and Process representations specified on the report configuration page 1400 and includes one or more common Process categories for which virtually benchmarking has or can occur. As shown in FIG. 17, Process models can desirably exist with respect to electrical reports, cost reports, schematics (for the facility or Process) and otherwise.

For at least one embodiment of the present invention, upon uploading a schematic for a facility, the various Processes used for the facility are identified and data tables and other structures within the database 108 are created. In short, the present invention can be used, in various embodiments, to specify a facility's structure and process flow by specifying the same in the database using the previously described dashboard, benchmark, report and other features.

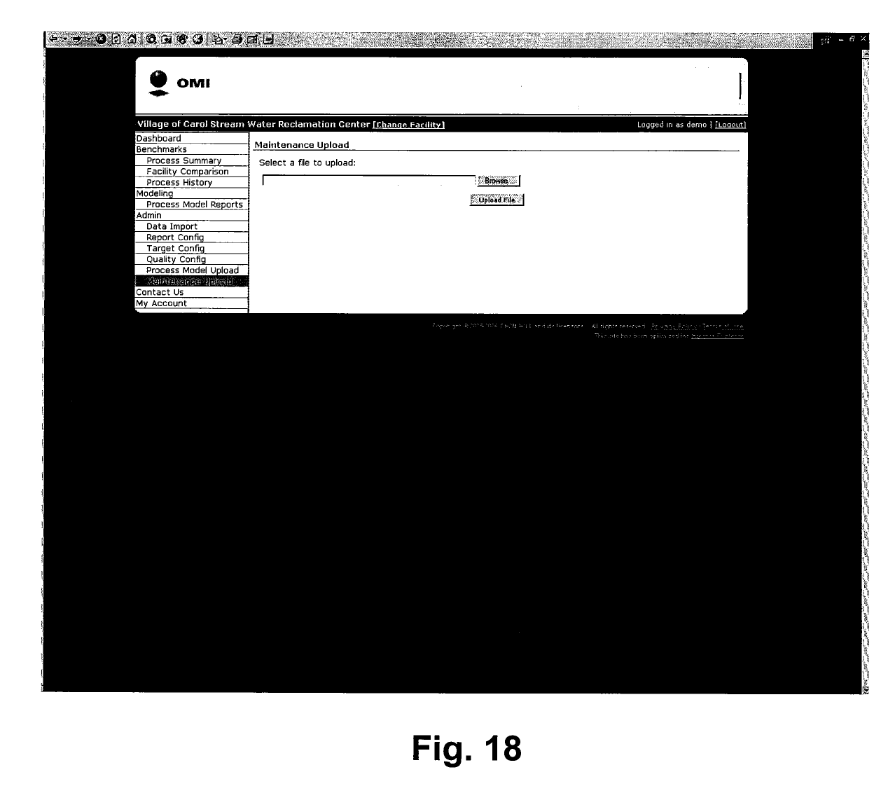

Referring now to FIG. 18, the various embodiments of the present invention can also be configured to support the monitoring, analysis and virtual benchmarking of maintenance data for a facility. In one embodiment, the server is configured to support maintenance data uploads from a maintenance reporting system such as CMMS. CMMS data and/or other maintenance data can be used by a user to assess the performance of their facility against other facilities and/or against a virtually benchmarked facility at any desired and/or monitored level of specificity. It is to be appreciated that maintenance data can also be combined, by the server, to create new Process categories and reports and other presentations reflecting the same. For example, a Process category might include a benchmarking of maintenance requirements for any desired level of specificity in a Process using, for example, decay rates, life cycle costs, future predictors and otherwise. Such Process category can also be compared to other facilities, using the same pump, and virtually benchmarked, as desired.

While the present invention has been described herein with reference to various embodiments, features, configurations, and the like, it is to be appreciated that the foregoing description is with respect to only a few of the possible embodiments of the present invention and is not to be construed as limiting the scope of invention. The present invention is to be construed as covering those systems and/or methods described above as well as any other systems and methods which are within the spirit and scope of the following claims and/or any subsequently added or amended claims.

1. A system for virtually benchmarking the performance of at least one component comprising:
a plurality of reporting computers, wherein each reporting computer receives information regarding at least one component;
a server configured to receive at least one report from each of the plurality of reporting computers, wherein the report includes a value reflective of an operating performance of the at least one component;
a communications medium connecting each of the plurality of reporting computers with the server; and
a database operably connected to the server and configured to store, upon receipt, each of the values provided by each of the plurality of reporting computers in a database wherein each component of the process is separately and uniquely identified such that a virtual benchmark for substantially similar components can be generated by the server and utilized to compare a cost value associated with a performance of the component at a given facility against a virtually benchmarked cost based performance.

2. The system of claim 1, wherein the component is utilized in an industrial process.

3. The system of claim 2, wherein the industrial process further comprises a wastewater treatment facility.

4. The system of claim 3, wherein the component is utilized to measure a flow of influent into the waste water treatment facility.

5. The system of claim 2, wherein the industrial process further comprises a potable water treatment facility.

6. The system of claim 2, wherein the industrial process further comprises a baggage handling system.

7. The system of claim 6, wherein the component is an item of luggage placed into the baggage handling system.

8. The system of claim 2, wherein the industrial process further comprises a financial reporting system.

9. The system of claim 1, wherein the component is utilized is an article of manufacture.

10. The system of claim 9, wherein the article of manufacture further comprises an integrated circuit.

11. The system of claim 9, wherein the article of manufacture further comprises an edible substance.

12. The system of claim 1, wherein the information further comprises aggregate information compiled over a period of time for the component.

13. The system of claim 12, wherein the aggregate information is compiled by the reporting computer.

14. The system of claim 12, wherein the information further comprises maintenance information for the component.

15. The system of claim 14, wherein the maintenance information is obtained from an CMMS system.

16. The system of claim 12, wherein the report includes aggregate information compiled over a period of time for the component.

17. The system of claim 16, wherein the report include maintenance information for the component.

18. The system of claim 1, wherein the value includes an aggregate information representative of the performance of the component over a given period of time.

19. The system of claim 1, wherein the database further comprises a matrix database.

20. The system of claim 19, wherein the matrix database utilizes a numbering scheme adapted to specify on a component basis each value received from a reporting computer.

21. The system of claim 20, wherein each of the plurality of reporting computers communicates to the server, for subsequent storage in the matrix database, each value using the numbering scheme.

22. The system of claim 21, wherein the server queries the database to provide all values associated with a given number, wherein the number is selected from those supported by the numbering scheme.

23. The system of claim 22, whereupon receiving a response from database to the query, the server combines the retrieved values and determines a virtual benchmark for the component.

24. The system of claim 23, wherein a quality ranking is associated with each retrieved value and the quality ranking is utilized by the server to weight each of the retrieved values when determining the virtual benchmark for the component.

25. The system of claim 24, wherein a confidence rating is associated with each retrieve value and the confidence rating is utilized by the server to weight each of the retrieved values when determining the virtual benchmark for the component.

26. The system of claim 25, wherein the reported value for the component for a first of the plurality of reporting computers is compared to the virtual benchmark for the component and the comparison is presented by the server to a user in at least one report.

27. A method for monitoring a process using a computer comprising:
receiving first information from each of a plurality of first facilities executing a process; wherein the information indicates the performance characteristics of each of the first facilities at a respective and desired level of specificity;
storing the first information in a database;
analyzing the first information received from each of the plurality of facilities, wherein a result of the analysis indicates a cost based virtual benchmark for an optimal facility at the desired level of specificity;
receiving second information associated with a second facility, wherein the second information indicates a performance characteristic of the second facility at the desired level of specificity; and
virtually benchmarking the second facility to the optimal facility at the desired level of specificity by comparing the second information to the result.

28. The method of claim 27, wherein the first information received is aggregate information for each of the plurality of first facilities.

29. The method of claim 28, wherein the first information received further comprises maintenance information for each of the plurality of first facilities.

30. The method of claim 29, wherein the analysis of the first information further comprises deriving new information based upon the first information and the maintenance information.

31. The method of claim 28, wherein the information is stored in a matrix database.

32. The method of claim 28, wherein the second information is utilized in the analysis.

33. The method of claim 28, further comprising receiving quality information, wherein each quality information is associated with one of the received first information.

34. The method of claim 33, wherein the analysis of the first information further comprises weighting the value of each first information received based upon the received quality information.

35. The method of claim 34, wherein the result is determined based upon a weighted value of each first information.

36. The method of claim 35, wherein quality information is received for only a subset of the received first information.

37. A computer readable medium containing a computer data structure accessible by a server comprising:
a data structure stored in the computer readable medium, the data structure including information resident in a database accessible by a server and including:
a first entry in the database, wherein the first entry specifies a performance characteristic for a facility at a given level of specificity;
a second entry in the database, wherein the second entries specifies a performance characteristic for a second facility at the given level of specificity; and
an addressing system identifying the first entry and the second entry as both referring to the given level of specificity.

38. The computer readable medium of claim 37, wherein the database further comprises a matrix database.

39. The computer readable medium of claim 38, wherein the database is accessed utilizing a structured query language.
